(19) United States
(12) Patent Application Publication
(10) Pub. No.: US 2024/0406896 A1
(43) Pub. Date: Dec. 5, 2024

(54) METHOD AND APPARATUS FOR SYNCHRONIZATION FOR RACH AND SDT IN SSB-LESS DL BWP

(71) Applicant: QUALCOMM Incorporated, San Diego, CA (US)

(72) Inventors: Jing LEI, San Diego, CA (US); Chao WEI, Beijing (CN); Peter GAAL, San Diego, CA (US)

(21) Appl. No.: 18/697,414

(22) PCT Filed: Dec. 2, 2022
(86) PCT No.: PCT/CN2022/136114

§ 371 Date: Mar. 29, 2024

(30) Foreign Application Priority Data
Dec. 3, 2021 (WO) PCT/CN2021/135467

(51) Int. Cl. H04W 56/00; H04W 72/0453; H04W 72/23

(52) U.S. Cl. CPC H04W 56/0015; H04W 72/0453; H04W 72/23

(57) ABSTRACT

Methods, apparatuses, and computer-readable medium for synchronization for RACH and SDT are provided. An example method may include receiving a configuration for a first DL and UL BWP pair including information indicative of at least one of a CORESET, a SS set, and a set of UL resource occasions for a RA procedure or a SDT procedure. The example method may further include initiating at least one of the RA procedure or the SDT procedure in the first DL and UL BWP pair. The example method may further include performing time or frequency synchronization during the RA procedure or the SDT procedure, using a SSB of a serving cell configured in a second DL BWP or a DL reference signal of the serving cell configured in the second DL BWP.

### CROSS REFERENCE TO RELATED APPLICATION(S)

This application claims the benefit of and priority to PCT Application Serial No. PCT/CN2021/135467, entitled “SYNCHRONIZATION FOR RACH AND SDT IN SSB-LESS DL BWP” and filed on Dec. 3, 2021, which is expressly incorporated by reference herein in its entirety.

### TECHNICAL FIELD

The present disclosure relates generally to communication systems, and more particularly, to wireless communication systems with downlink (DL) bandwidth part (BWP) without synchronization signal block (SSB) for random access (RA) procedure or small data transmission (SDT) procedure.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive a configuration for a first downlink (DL) and uplink (UL) bandwidth part (BWP) pair including information indicative of at least one of a control resource set (CORESET), a search space (SS) set, and a set of UL resource occasions for a random access (RA) procedure or a small data transmission (SDT) procedure. The memory and the at least one processor coupled to the memory may be further configured to initiate at least one of the RA procedure or the SDT procedure in the first DL and UL BWP pair. The memory and the at least one processor coupled to the memory may be further configured to perform time or frequency synchronization during the RA procedure or the SDT procedure, using a synchronization signal block (SSB) of a serving cell configured in a second DL BWP or a DL reference signal of the serving cell configured in the second DL BWP (e.g., or in a first DL BWP of the first DL and UL BWP pair).

In another aspect of the disclosure, a method, a computer-readable medium, and an apparatus at a base station (e.g., a network node) are provided. The apparatus may include a memory and at least one processor coupled to the memory. The memory and the at least one processor coupled to the memory may be configured to transmit, to a UE in a radio resource control (RRC) idle, inactive or connected state, a configuration for random access procedure or a SDT procedure in a first downlink and uplink BWP pair, including information indicative of at least one of a CORESET, a SS set (such as a common SS (CSS) or a UE specific SS (USS) set), a set of uplink resource occasions for the random access procedure or the SDT procedure, and a SSB or DL reference signal in a second DL BWP, where a first DL BWP of the first DL and UL BWP pair does not include the SSB, and a quasi-colocation (QCL) source, a spatial relation configuration and synchronization for the UE during the random access procedure or the SDT procedure are based on the SSB or the DL reference signal transmitted by a serving cell in the second DL BWP. The memory and the at least one processor coupled to the memory may be further configured to receive an early indication from the UE for one or more of a device type, a first request for a first on-demand transmission of the SSB or the DL reference signal, or assistance information for adaptive scheduling in at least one of a random access message or an SDT message from the UE in a first UL BWP in the first DL and UL BWP pair.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating example resources with multiple BWPs configured within a frequency span of the carrier bandwidth.

FIG. 5 is a diagram illustrating an initial downlink BWP.

FIG. 6 is a diagram illustrating a four-step random access procedure (4-step RACH).

FIG. 7 is a diagram illustrating a two-step random access procedure (2-step RACH).

FIG. 8 is a diagram illustrating example timeline associated with 4-step RACH.

FIGS. 9A and 9B are diagrams illustrating example timelines associated with retuning timers.

FIG. 10 is a diagram illustrating example timeline associated with retuning.

FIG. 11 is a diagram illustrating example timeline associated with retuning.

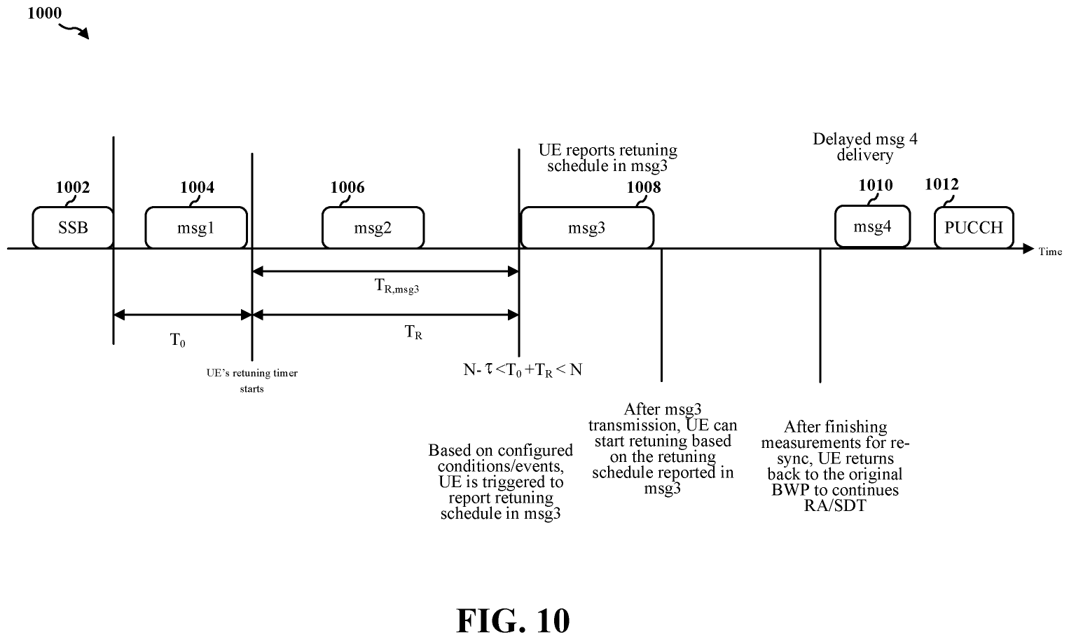

FIG. 10 is a diagram illustrating example timeline associated with retuning.

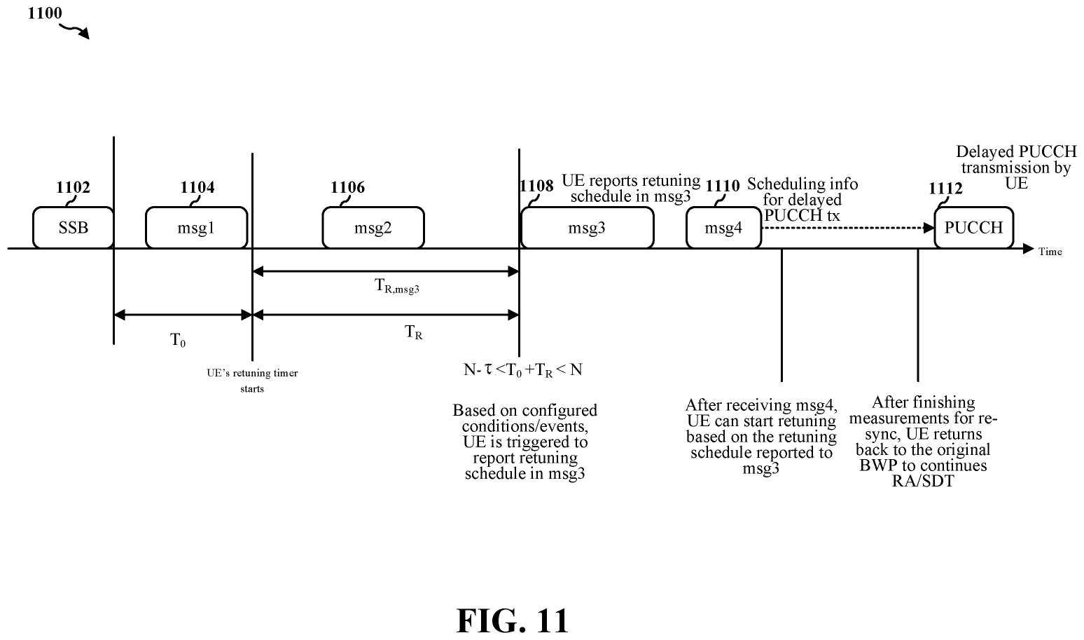

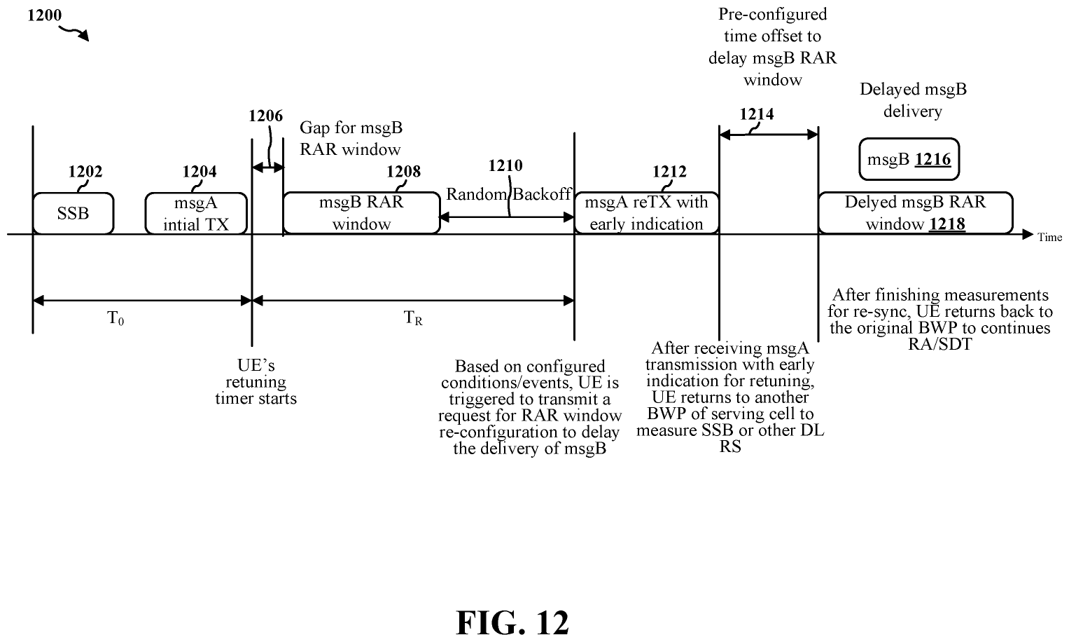

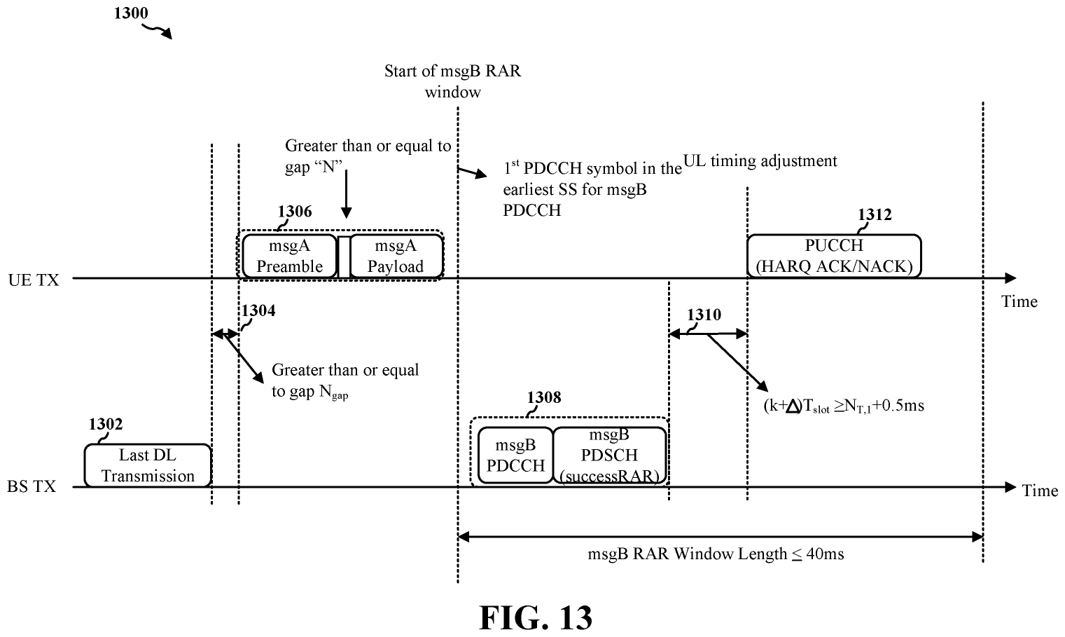

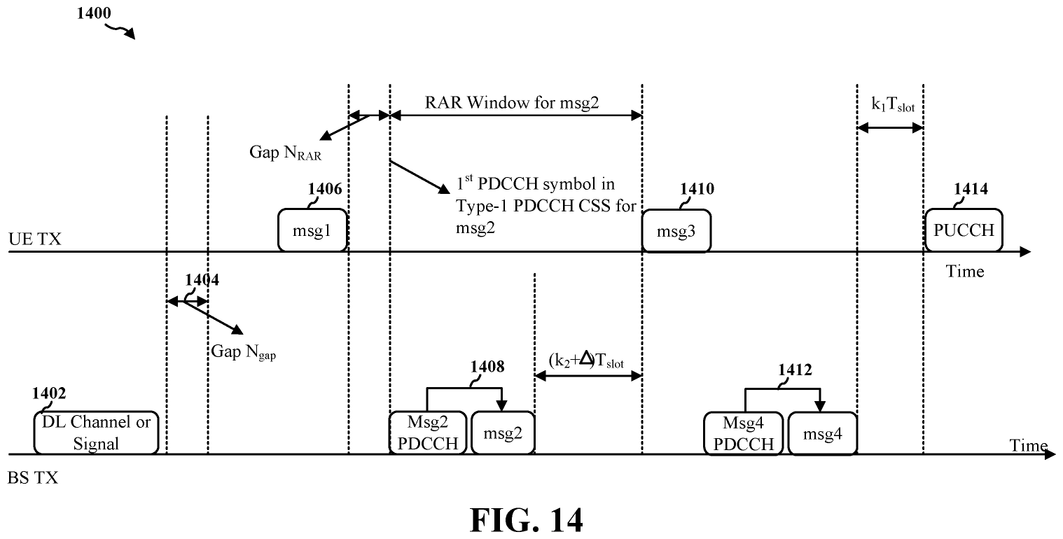

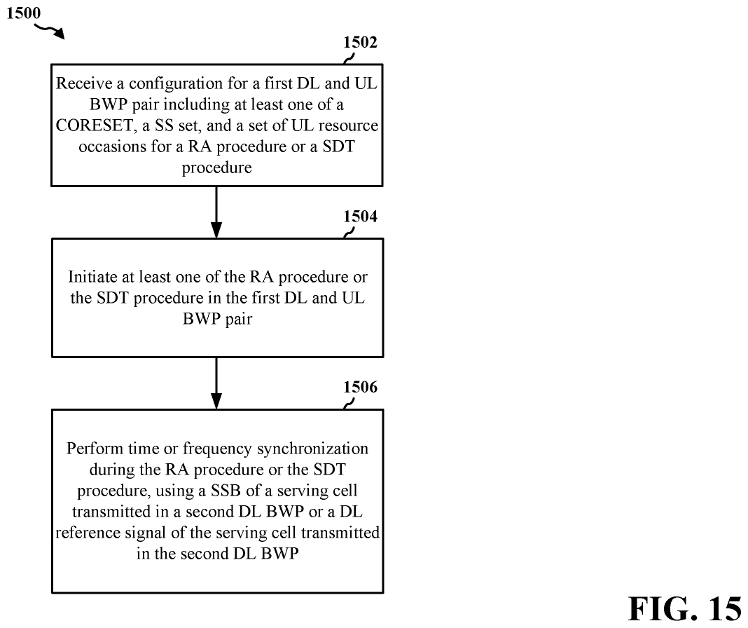

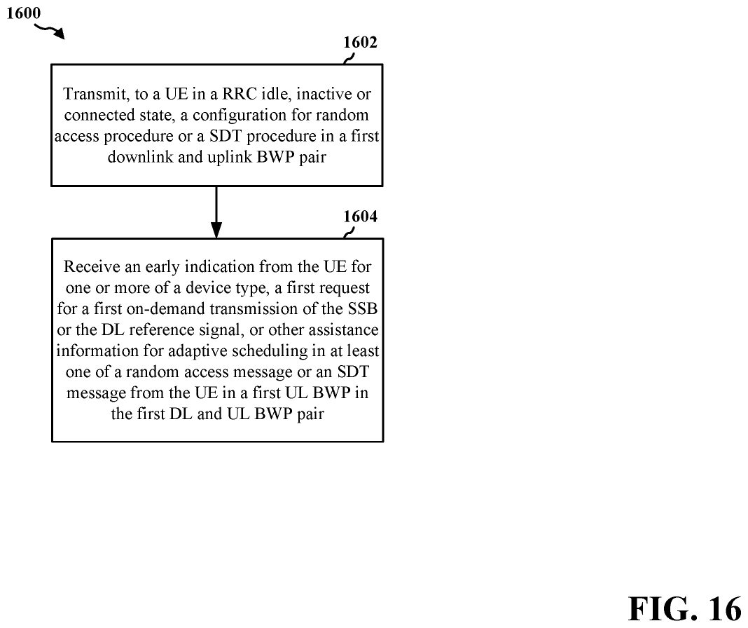

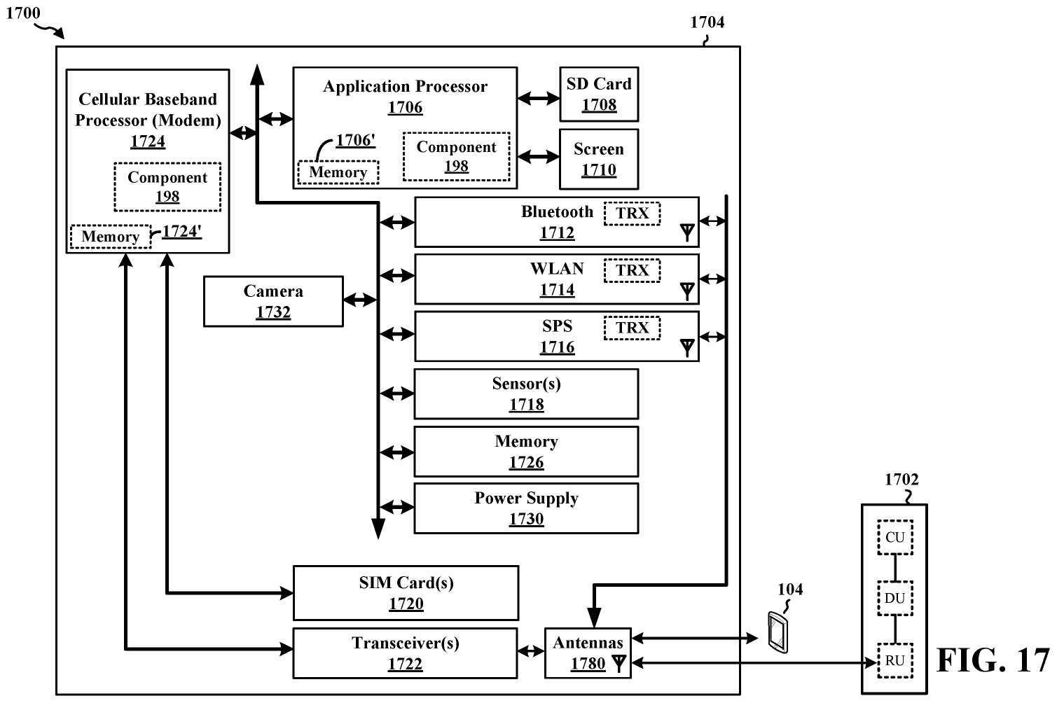

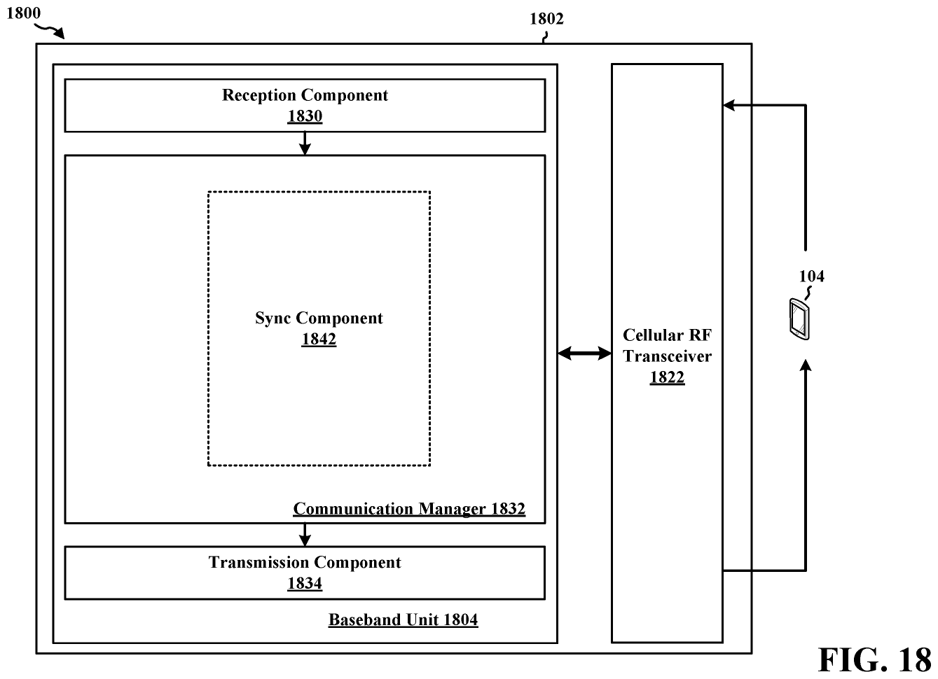

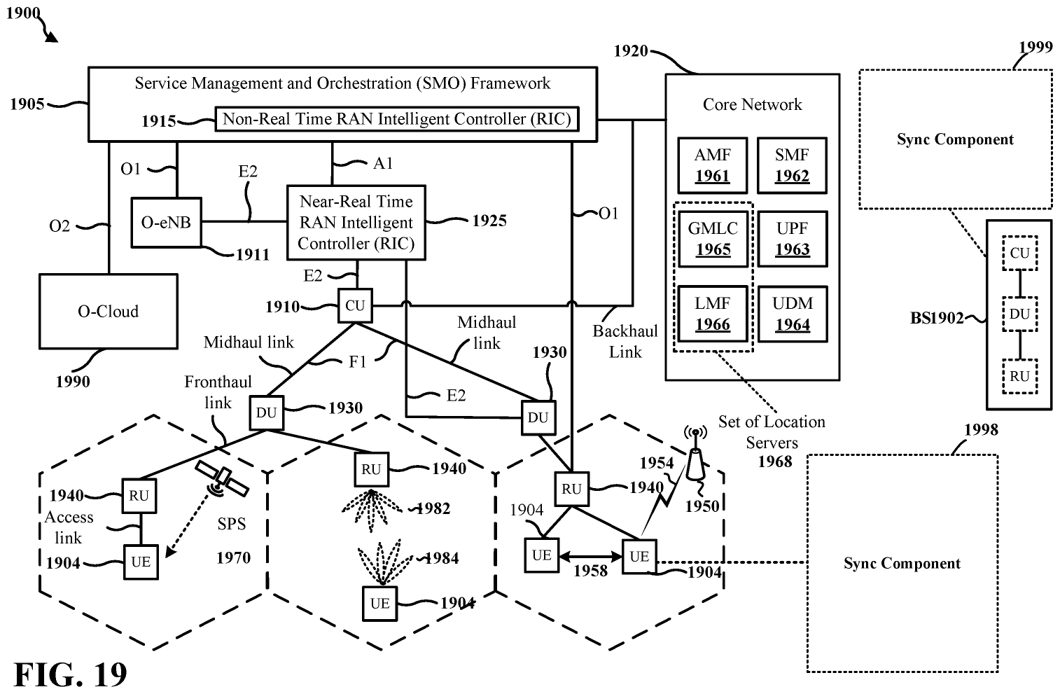

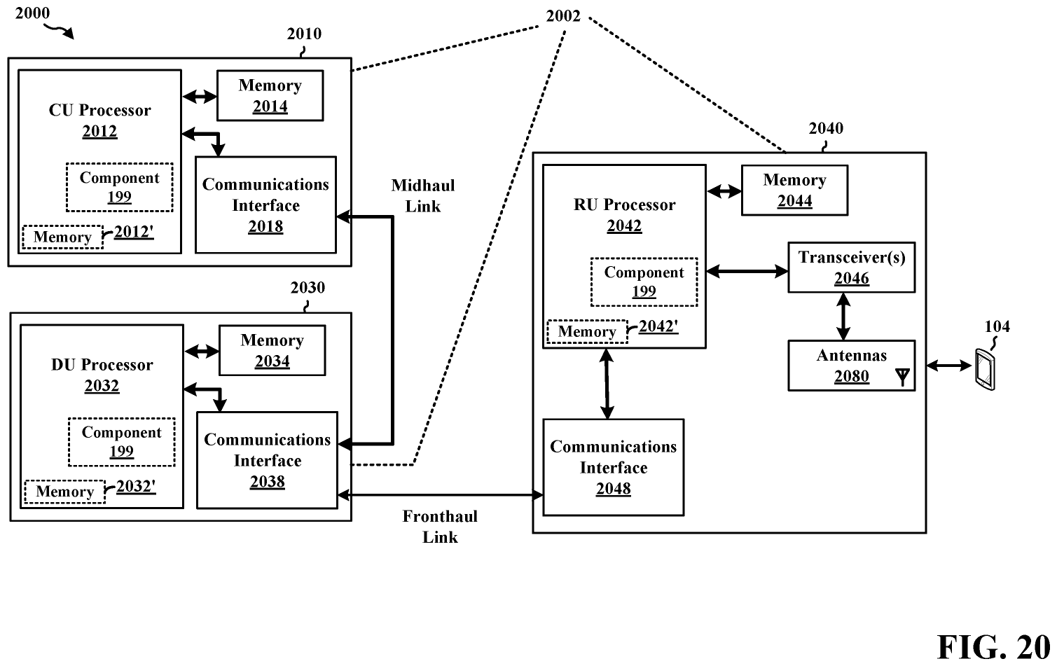

FIG. 11 is a diagram illustrating example timeline associated with retuning.

FIG. 12 is a diagram illustrating example timeline associated with retuning.

FIG. 13 is a diagram illustrating example timeline associated with 2-step RACH.

FIG. 14 is a diagram illustrating example timeline associated with 4-step RACH.

FIG. 15 is a flowchart of a method of wireless communication.

FIG. 16 is a flowchart of a method of wireless communication.

FIG. 17 is a diagram illustrating an example of a hardware implementation for an example apparatus.

FIG. 18 is a diagram illustrating an example of a hardware implementation for an example apparatus.

FIG. 19 is a diagram illustrating an example of a wireless communications system and an access network.

FIG. 20 is a diagram illustrating an example of a hardware implementation for a network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

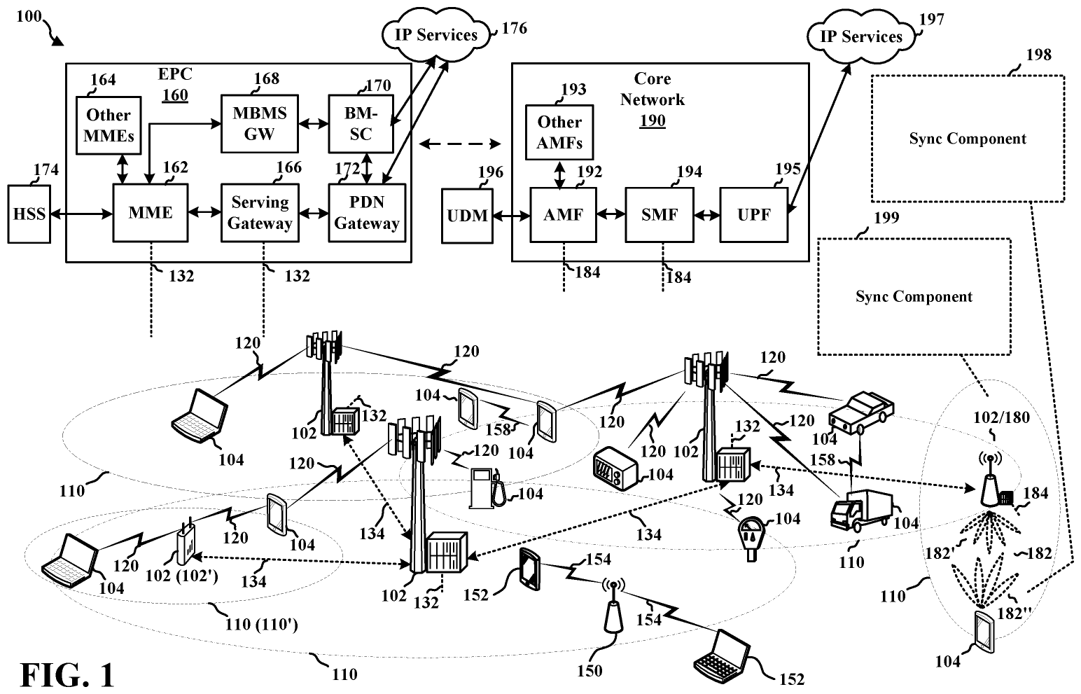

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a sync component 198. In some aspects, the sync component 198 may be configured to receive a configuration for a first DL and UL BWP pair including information indicative of at least one of a CORESET, a SS set, and a set of UL resource occasions for a RA procedure or a SDT procedure. In some aspects, the sync component 198 may be further configured to initiate at least one of the RA procedure or the SDT procedure in the first DL and UL BWP pair. In some aspects, the sync component 198 may be further configured to perform time or frequency synchronization during the RA procedure or the SDT procedure, using a SSB of a serving cell configured in a second DL BWP or a DL reference signal of the serving cell configured in the second DL BWP (e.g., or in a first DL BWP of the first DL and UL BWP pair).

In some aspects, the base station 180 may include a sync component 199. In some aspects, the sync component 199 may be configured to transmit, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP. In some aspects, the sync component 199 may be further configured to receive an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

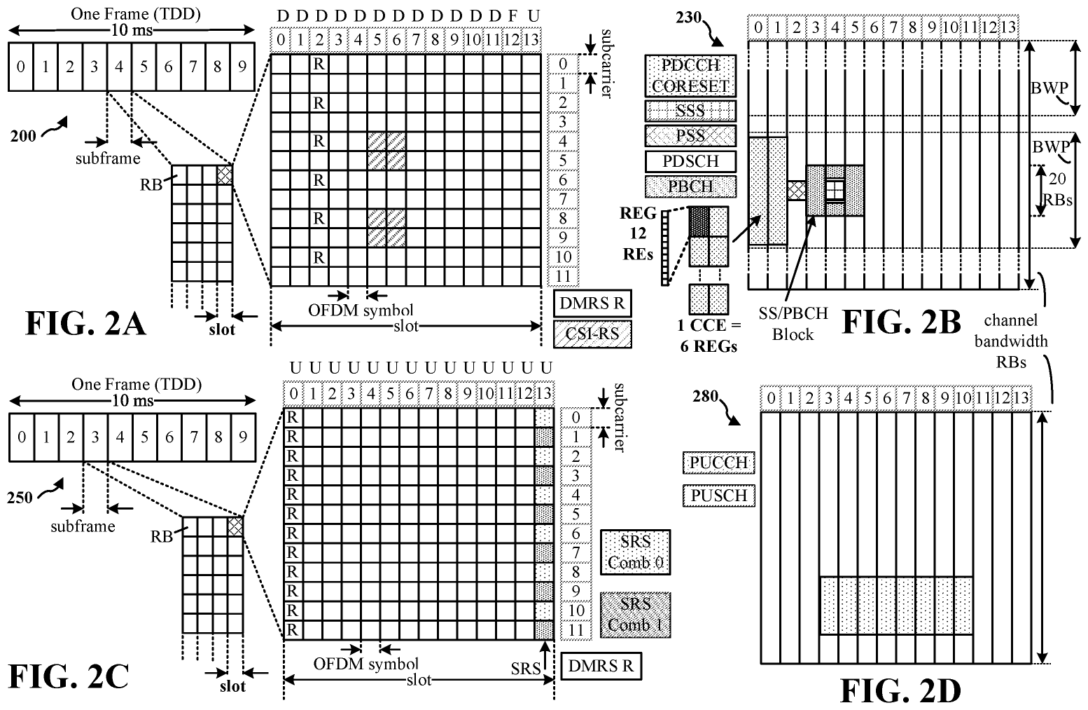

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 24*15 kHz where μ is the numerology 0 to 4. As such, the numerology μ=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

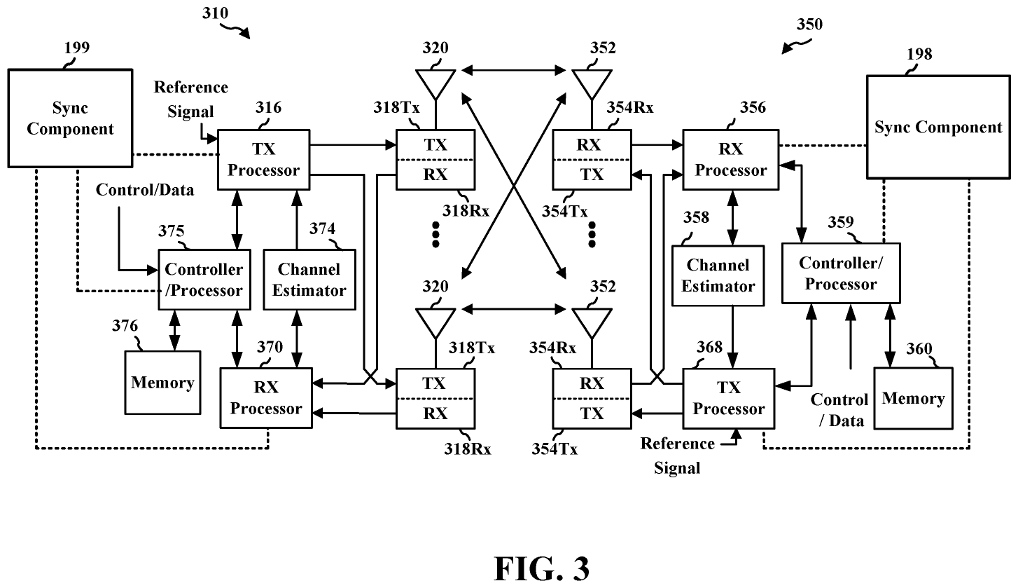

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with sync component 198 of FIG. 1.

At least one of the TX processor 316, the RX processor 370, and the controller/processor 375 may be configured to perform aspects in connection with sync component 199 of FIG. 1.

In addition to regular devices, wireless communication may also be supported on devices with reduced capability (also reduced capability devices). Among others, examples of regular devices include premium smartphones, V2X devices, URLLC devices, eMBB devices, etc. Among other examples, reduced capability devices may include wearables (e.g., such as smart watches, augmented reality glasses, virtual reality glasses, health and medical monitoring devices, etc.), industrial wireless sensor networks (IWSN) (e.g., such as pressure sensors, humidity sensors, motion sensors, thermal sensors, accelerometers, actuators, etc.), surveillance cameras, low-end smartphones, etc. For example, NR communication systems may support both regular devices and reduced capability devices. A reduced capability device may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In some examples, a reduced capability UE may have an uplink transmission power of at least 10 dB less than that a regular UE. As another example, a reduced capability UE may have reduced transmission bandwidth or reception bandwidth than other UEs. For instance, a reduced capability UE may have an operating bandwidth between 5 MHz and 20 MHz for both transmission and reception, in contrast to other UEs which may have a bandwidth of up to 100 MHZ. As an example, a reduced capability UE may have a maximum bandwidth of 20 MHz during and after initial access in FR1. In FR2, a reduced capability UE may have a maximum bandwidth of 100 MHz during and after initial access. As a further example, a reduced capability UE may have a reduced number of reception antennas in comparison to other UEs. For frequency bands where a UE is equipped with at least two antennas, a minimum number of reception branches for a reduced capability UE may be 1, and may also include support for 2 reception branches. For frequency bands where a regular UE is equipped with four reception antenna ports, a minimum number of 1 reception branches may be supported, e.g., with additional support for 2 reception branches for a reduced capability UE. In some aspects, a base station may know the number of reception branches at the UE. A reduced capability UE may have only a single receive antenna and may experience a lower equivalent receive signal to noise ratio (SNR) in comparison to regular UEs that may have multiple antennas. A reduced capability UE with 1 reception branch may support 1 downlink MIMO layer. A reduced capability UE with two reception branches may support two downlink MIMO layers. A maximum modulation order of 256 QAM may be supported in the downlink for an FR1 reduced capability UE. In some aspects, the reduced capability UE may support a half-duplex frequency division duplex (HD-FDD) type A duplex operation. The reduced capability UE may support a full-duplex FDD (FD-FDD) operation or a full-duplex time division duplex (FD-TDD) operation. Reduced capability UEs may also have reduced computational complexity than other UEs.

As an example, a wearable may have a downlink heavy data rate, e.g., a reference rate of 5-50 Mbps on downlink compared to a rate of 2-5 Mbps on uplink. The latency and reliability may be based on eMBB. The battery life may be intended to last for multiple days, e.g., 1-2 weeks in one example. An industrial sensor may have uplink heavy reference rates, e.g., of around 2 Mbps, a latency of less than 100 ms with a smaller latency (e.g., 5-10 ms) for safety related sensors, a reliability of 99.9%, and may have a battery life that is intended to last for one or more years. A video surveillance device may have an uplink heavy traffic, e.g., with reference rates of 2-4 Mbps for some traffic and 7.5-25 Mbps for higher priority traffic. The video surveillance device may have a latency of less than 500 ms with a reliability of 99%-99.9%.

It may be helpful for communication to be scalable and deployable in a more efficient and cost-effective way. For example, it may be possible to relax or reduce peak throughput, latency, and/or reliability requirements for the reduced capability devices. In some examples, reductions in power consumption, complexity, production cost, and/or reductions in system overhead may be prioritized. As an example, industrial wireless sensors may have an acceptable latency up to approximately 100 ms. In some safety related applications, the latency of industrial wireless sensors may be acceptable up to 10 ms or up to 5 ms. The data rate may be lower and may include more uplink traffic than downlink traffic. As another example, video surveillance devices may have an acceptable latency up to approximately 500 ms.

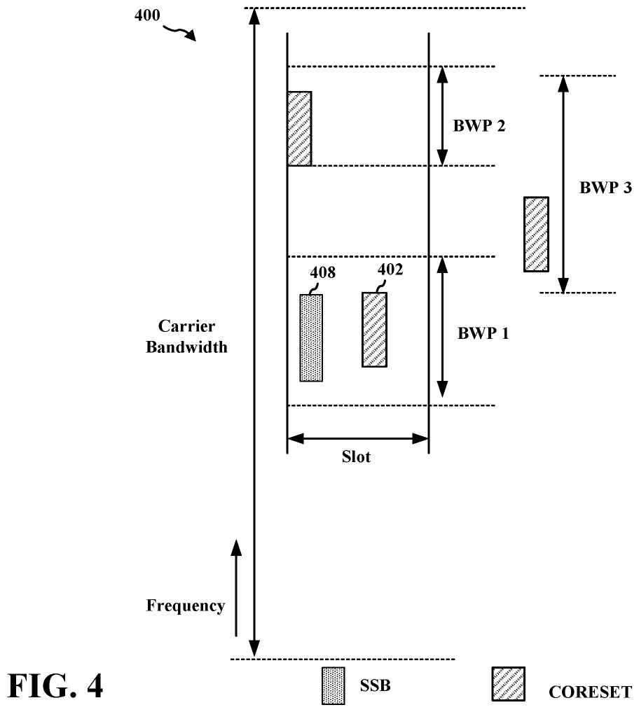

A carrier bandwidth may span a contiguous set of PRBs, e.g., from common resources blocks for a given numerology on a given carrier. A base station may configure one or more bandwidth parts (BWPs) that have a smaller bandwidth span than the carrier bandwidth. One or more of the BWPs may be configured for downlink communication, and may be referred to as a downlink (DL) BWP. FIG. 4 illustrates a resource diagram 400 showing multiple BWPs (e.g., BWP 1, BWP 2, and BWP 3) configured within a frequency span of the carrier bandwidth. One DL BWP may be active at a time, and the UE may not be expected to receive PDSCH, PDCCH, CSI-RS, or TRS outside of an active BWP without a measurement gap or BWP switching gap. Each DL BWP may include at least one control resource set (CORESET). In FIG. 4, the BWPs may be DL BWPs and are illustrated as having a CORESET within the BWP. In other examples, the BWP may be an UL BWP and may not include a CORESET configuration. One or more of the BWPs may be configured for uplink communication, and may be referred to as an uplink (UL) BWP. One UL BWP may be active at a time for the UE, and the UE may not transmit PUSCH or PUCCH outside of the active BWP. The use of a BWP may reduce the bandwidth monitored by the UE and/or used for transmissions, which may help the UE to save battery power.

A CORESET corresponds to a set of physical resources in time and frequency that a UE uses to monitor for PDCCH/DCI. Each CORESET comprises one or more resource blocks in the frequency domain and one or more symbols in the time domain. As an example, a CORESET might comprise multiple RBs in the frequency domain and 1, 2, or 3 contiguous symbols in the time domain. A Resource Element (RE) is a unit indicating one subcarrier in frequency over a single symbol in time. A Control Channel Element (CCE) includes Resource Element Groups (REGs), e.g., 6 REGs, in which an REG may correspond to one RB (e.g., 12 REs) during one OFDM symbol. REGs within a CORESET may be numbered in increasing order in a time-first manner, starting with 0 for the first OFDM symbol and the lowest-numbered resource block in the control resource set. A UE can be configured with multiple CORESETs, each CORESET being associated with a CCE-to-REG mapping. A search space may comprise a set of CCEs, e.g., at different aggregation levels. For example, the search space may indicate a number of candidates to be decoded, e.g., in which the UE performs decoding. A CORESET may comprise multiple search space sets.

In some aspects, UEs having different levels of capabilities, such as reduced capability UEs and non-reduced capability (or regular) UEs, may share an initial DL BWP (e.g., BWP 1) and CORESET #0 (e.g., 402) for initial access. The UEs may monitor the resources of CORESET #0 to receive system information that enable the UEs to perform initial access, for example. A cell-defining SSB (CD-SSB), e.g., 408, may be transmitted within a bandwidth supported by the reduced capability UEs. As an example, the BWP 1 may be an initial DL BWP, e.g., which may be configured for both, reduced capability UEs and regular UEs. The UEs may be configured with a different BWP as an active DL BWP, e.g., after performing initial access. For example, in FIG. 4, the BWP 2 may be configured for lower capability UEs, and the regular UEs may be configured with the active DL BWP 3. FIG. 4 illustrates that the BWP 1 may include an SSB 408.

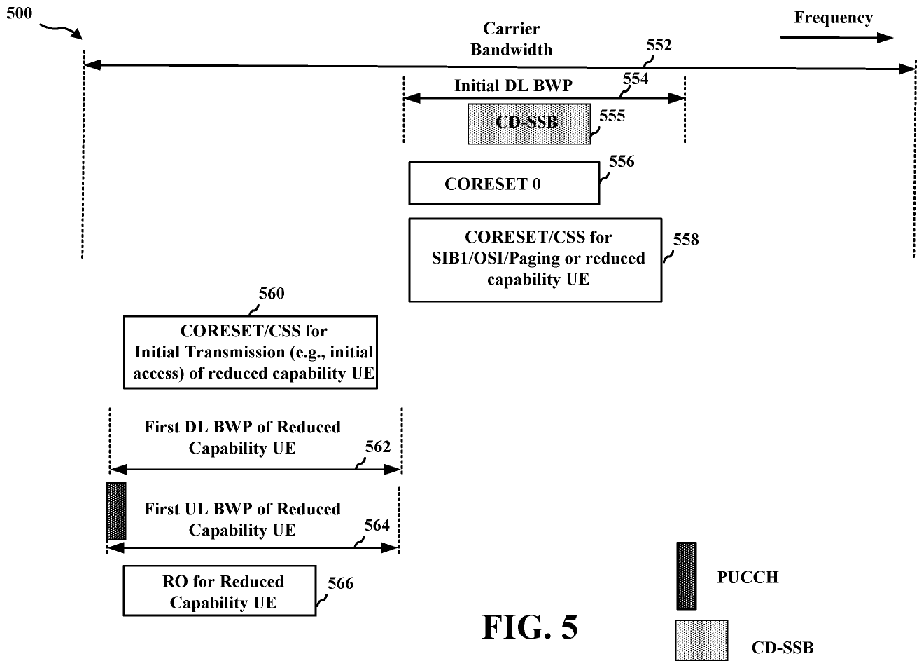

A cell that provides access to a reduced capability UE may configure a separate initial BWP for the reduced capability UEs. FIG. 5 illustrate an example diagram 500 showing an initial downlink BWP 554 that may be configured within a carrier bandwidth 552 of a serving cell for reduced capability UEs to receive a cell-defining (CD) SSB (CD-SSB), SI, paging information, etc. In some aspects, the initial downlink BWP 554 may be configured with resources for a CD-SSB 555, a CORESET #0 556, and another CORESET and one or more SS(s) 558 for the UE to receive SIB1, other system information (OSI), or paging. An idle or inactive mode reduced capability UE may camp on the initial downlink BWP 554, e.g., on CORESET #0 556 of the serving cell to receive the CD-SSB, SI, and paging. The idle or inactive mode reduced capability UE may switch to a separate BWP to perform a random access procedure, small data transmission (SDT) procedure, or to initiate a transfer to a connected mode. The UE may receive a configuration for BWP pair, e.g., first BWP pair including a first downlink BWP 562 and an first uplink BWP 564 for the random access or SDT procedure. In some aspects, the first downlink BWP 562 and the first uplink BWP 564 may be initial DL BWP and initial UL BWP. In some aspects, the term “first BWP pair” may refer to “initial BWP pair” or another type of BWP pair. The first downlink BWP 562 may include resources 560 configured for a CORESET and USS/CSS for initial transmissions (e.g., initial access) by the reduced capability UE. The first uplink BWP 564 may include PUCCH resources and may include a physical random access channel (RACH) occasion (RO) 566, for example. The RAN may assume that an idle or inactive mode reduced capability UE that performs a random access procedure in the separate, e.g., first BWP (e.g., transmitting a random access message in the first uplink BWP 564 and/or monitoring for a downlink response in the first downlink BWP 562) does not monitor for paging in the CORESET0 556.

In some aspects, a separate, e.g., first BWP (e.g., 562) for the reduced capability UEs may include a CD-SSB, and a particular CORESET, such as CORESET 0. In other aspects, the separate, e.g., first BWP (e.g., 562) for the reduced capability UEs may not include a CD-SSB (e.g., being configured without a CD-SSB, not including a CD-SSB, etc., which may be referred to as an SSB-less BWP), and without a particular CORESET, such as resources for a CORESET #0, or without the CORESET for the reception of SIB1, OSI, or paging. FIG. 5 illustrates the separate, e.g., first DL BWP 562 for performing random access procedures that does not include a CD-SSB or a CORESET #0.

In some aspects in FR1, for a separate, e.g., first DL BWP (e.g., such as 562) that does not include CD-SSB and the CORESET #0 (e.g., does not include the entire CORESET #0), may be configured for performing random access procedures and not for paging in idle or inactive mode. The separate, e.g., first DL BWP (e.g., 562) may not contain SSB, CORESET #0, or SIB resources. For example, the network may assume that the reduced capability UE that is performing a random access procedure in the separate, e.g., first downlink BWP (e.g., 562) does not monitor paging in a BWP (e.g., 554) containing CORESET #0 556. If a BWP is configured for paging, the reduced capability UE may expect the BWP to contain a non-cell defining SSB (NCD-SSB) but may not expect the BWP to include a CORESET #0/SIB. For an RRC-configured active DL BWP configured for the UE in a connected mode, and if the active DL BWP does not include the CD-SSB or the entire CORESET #0), the reduced capability UE may expect the active DL BWP to include a NCD-SSB, e.g., but not a CORESET #0/SIB. In some aspects, the reduced capability UE may indicate a capability in which the UE does not need an NCD-SSB. For example, the reduced capability UE may optionally support relevant operation for wireless communication based on reference signals, such as CSI-RS, and may report the capability to the network.

If the network configures a separate RRC configured DL BWP for the reduced capability UE to contain the entire CORESET #0, the reduced capability UE may expect the separate BWP to include a CD-SSB. The network may choose to configure an SSB or a MIB-configured CORESET #0 or SIB1 to be within the respective DL BWP. When a separate SIB-configured initial DL BWP for the reduced capability UE contains the entire CORESET #0, the reduced capability UE may use the bandwidth and location of the CORESET #0 for downlink receptions during initial access. An NCD-SSB periodicity may be different than a periodicity of a CD-SSB. In some aspects, a periodicity of an NCD-SSB may not be less than a periodicity of a CD-SSB.

In some aspects in FR2, a separate, e.g., first DL BWP (e.g., 562) that does not include a CD-SSB or the entire CORESET #0) may be configured for performing a random access procedure and not for paging in an idle or inactive mode. The separate, e.g., first DL BWP (e.g., 562) may not contain a SSB, CORESET #0, or SIB resources. For example, the network may assume that the reduced capability UE that is performing a random access procedure in the separate downlink BWP (e.g., 562) does not monitor paging in a BWP (e.g., 554) containing CORESET #0 556. If the separate, e.g., first DL BWP is configured for paging, the reduced capability UE may expect the separate initial BWP to contain an NCD-SSB for serving cell but not CORESET #0 or SIB resources.

For an RRC-configured active DL BWP configured for the UE in a connected mode, and if the active DL BWP does not include the CD-SSB or the entire CORESET #0, the reduced capability UE may expect the active DL BWP to include a NCD-SSB for the serving cell, e.g., but not a CORESET #0/SIB. In some aspects, the reduced capability UE may indicate a capability in which the UE does not need an NCD-SSB. For example, the reduced capability UE may optionally support relevant operation for wireless communication based on a reference signal, such as CSI-RS, and may report the capability to the network.

For an SSB and CORESET #0 multiplexing pattern 1, if a separate initial DL BWP is configured via RRC to contain the entire CORESET #0, the reduced capability UE may expect the separate initial DL BWP to include a CD-SSB. The network may choose to configure an SSB or a MIB-configured CORESET #0 or SIB₁ to be within the respective DL BWP. If a separate SIB-configured initial DL BWP for the reduced capability UE contains the entire CORESET #0, the the reduced capability UE may use the bandwidth and location of the CORESET #0 for downlink reception during initial access. An NCD-SSB periodicity may be different than a periodicity of a CD-SSB. In some aspects, a periodicity of an NCD-SSB may not be less than a periodicity of a CD-SSB.

A UE may use a random access procedure in order to communicate with a base station. For example, the UE may use the random access procedure to request an RRC connection, to re-establish an RRC connection, resume an RRC connection, etc. Random access procedures may include two different types of random access procedures, Contention-Based Random Access (CBRA) may be performed, e.g., when a UE is not synchronized with a base station, and Contention-Free Random Access (CFRA) may be performed, e.g., when the UE was previously synchronized to a base station 604. Both types of the procedure include transmission of a random access preamble from the UE to the base station. In CBRA, a UE may randomly select a random access preamble sequence, e.g., from a set of preamble sequences. As the UE randomly selects the preamble sequence, the base station may receive other preambles based on the same preamble sequence from different UEs at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention-free” random access.

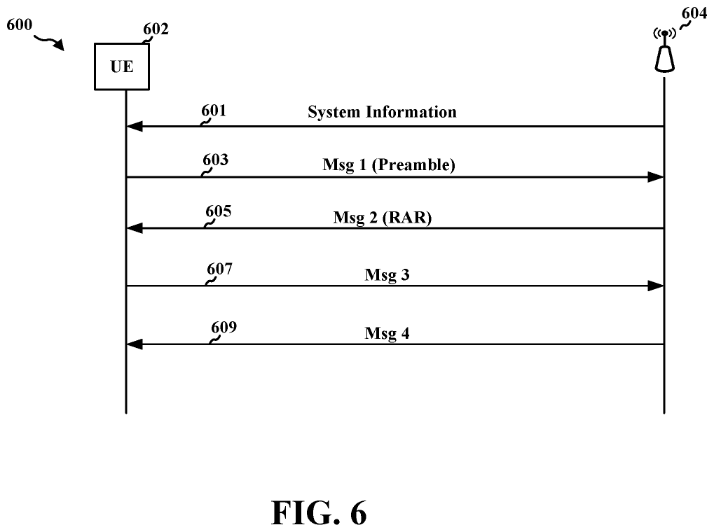

FIG. 6 illustrates example aspects of a four-step rand(Pm access procedure 600 between a UE 602 and a base station 604. The UE 602 may initiate the random access message exchange by sending, to the base station 604, a first random access message 603 (e.g., Msg 1) including a preamble. Prior to sending the first random access message 603, the UE may obtain random access parameters, e.g., including preamble format parameters, time and frequency resources, parameters for determining root sequences and/or cyclic shifts for a random access preamble, etc., e.g., in system information 601 from the base station 604. The preamble may be transmitted with an identifier, such as a Random Access RNTI (RA-RNTI). The UE 602 may randomly select a random access preamble sequence, e.g., from a set of preamble sequences. If the UE 602 randomly selects the preamble sequence, the base station 604 may receive another preamble from a different UE at the same time. In some examples, a preamble sequence may be assigned to the UE 602.

The base station responds to the first random access message 603 by sending a second random access message 605 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR 605, the UE 602 may transmit a third random access message 607 (e.g., Msg 3) to the base station 604, e.g., using PUSCH, that may include a RRC connection request, an RRC connection re-establishment request, or an RRC connection resume request, depending on the trigger for the initiating the random access procedure. The base station 604 may then complete the random access procedure by sending a fourth random access message 609 (e.g., Msg 4) to the UE 602, e.g., using PDCCH for scheduling and PDSCH for the message. The fourth random access message 609 may include a random access response message that includes timing advancement information, contention resolution information, and/or RRC connection setup information. The UE 602 may monitor for PDCCH, e.g., with the C-RNTI. If the PDCCH is successfully decoded, the UE 602 may also decode PDSCH. The UE 602 may send HARQ feedback for any data carried in the fourth random access message. If two UEs sent a same preamble at 603, both UEs may receive the RAR leading both UEs to send a third random access message 607. The base station 604 may resolve such a collision by being able to decode the third random access message from only one of the UEs and responding with a fourth random access message to that UE. The other UE, which did not receive the fourth random access message 609, may determine that random access did not succeed and may re-attempt random access. Thus, the fourth message may be referred to as a contention resolution message. The fourth random access message 609 may complete the random access procedure. Thus, the UE 602 may then transmit uplink communication and/or receive downlink communication with the base station 604 based on the RAR 609.

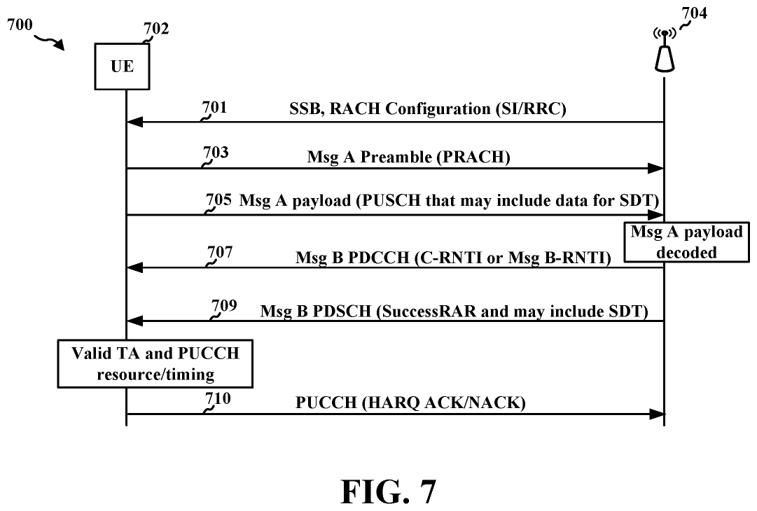

In order to reduce latency or control signaling overhead, a single round trip cycle between the UE and the base station may be achieved in a 2-step RACH process, such as shown in example 700 of FIG. 7. Aspects of Msg 1 and Msg 3 may be combined in a single message, e.g., which may be referred to as Msg A. Prior to sending the first random access message 703, the UE 702 may obtain random access parameters, e.g., including preamble format parameters, time and frequency resources, parameters for determining root sequences and/or cyclic shifts for a random access preamble, etc., e.g., in the SSB or RACH configuration (e.g., system information or RRC signaling) at 701 from the base station 704. The UE 702 transmits a Msg A which may include a random access preamble 703, and which may also include a PUSCH transmission 705, e.g., such as data for a small data transmission (SDT). The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions that may span multiple symbols and PRBs. After the UE 702 transmits the Msg A (e.g., 703 and/or 705), the UE 702 may wait for a response from the base station 704. Aspects of the Msg 2 and Msg 4 in the four-step RACH of FIG. 6 may be combined into a single message, which may be referred to as Msg B. The two-step RACH may be triggered for reasons similar to a four-step RACH procedure. If the UE 702 does not receive a response, the UE 702 may retransmit the MsgA or may fall back to a four-step RACH procedure starting with a Msg 1. If the base station 704 detects the Msg A, but fails to successfully decode the Msg A PUSCH, the base station 704 may respond with an allocation of resources for an uplink retransmission of the PUSCH. The UE 702 may fall back to the four step RACH with a transmission of Msg 3 based on the response from the base station and may retransmit the PUSCH from Msg A. If the base station 704 successfully decodes the Msg A and corresponding PUSCH, the base station 704 may reply with an indication of the successful receipt, e.g., as a random access response that completes the two-step RACH procedure. FIG. 7 shows that the Msg B may include a Msg B PDCCH 707 and a Msg B PDSCH 709 indicating the successful receipt, e.g., RAR. The Msg B may include the random access response and a contention-resolution message. The contention resolution message may be sent after the base station successfully decodes the PUSCH transmission. In some aspects, the Msg B PDSCH 709 may include data, e.g., as part of an SDT. The UE may then have a valid timing advance (TA) and PUCCH resource timing. The UE 702 may transmit a PUCCH 710 with ACK/NACK feedback for the Msg B received from the base station 704.

In some wireless communication systems, a UE's initial transmission timing error may be less than or equal to a timing error limit value Tₑ. For example, such initial transmissions may occur after a UEs has been inactive for some time, e.g., sleep state when configured in a discontinuous reception (DRX) mode. The timing error limit value Tₑ may be specified by the table below:

TABLE 2

| Frequency | SCS of SSB | SCS of uplink | |
|---|---|---|---|
| Range | signals (kHz) | signals (kHz) | Tₑ |
| 1 | 15 | 15 | 12*64*T_{c} |
| | | 30 | 10*64*T_{c} |
| | | 60 | 10*64*T_{c} |
| | 30 | 15 | 8*64*T_{c} |
| | | 30 | 8*64*T_{c} |
| | | 60 | 7*64*T_{c} |
| 2 | 120 | 60 | 3.5*64*T_{c} |
| | | 120 | 3.5*64*T_{c} |
| | 240 | 60 | 3*64*T_{c} |
| | | 120 | 3*64*T_{c} |

As in the example in Table 2, the timing error limit value Tₑ may be defined based on a basic timing unit T. In some aspects, the timing error limit value Tₑ may be applicable for a first transmission in a DRX cycle for PUCCH, PUSCH and SRS, or if a transmission is a PRACH transmission or a msgA transmission. As an example, UEs are generally expected to meet the timing error limit value Tₑ for an initial transmission provided that at least one SSB is available at the UE during the last 160 ms. The reference point for the UE's initial transmission timing control may be the downlink timing of the reference cell minus (N_{TA}+N_{TA ofset})×T_{c}. The downlink timing may be defined as the time when the first detected path (in time) of the corresponding downlink frame is received from the reference cell. The value N_{TA} may be referred to as timing advance between downlink and uplink, and may be provided to a UE via a timing advance command MAC-CE, including T_{A}. For PRACH N_{TA} may be 0. The value N_{TA} offset may be referred to as timing advance offset and may be provided to a UE via Information Element (IE) n-TimingAdvanceOffset for the serving cell. (N_{TA}+N_{TA offset})×T_{c} (in T_{c} units) for other channels may be the difference between UE transmission timing and the downlink timing immediately after when the last timing advance was applied.

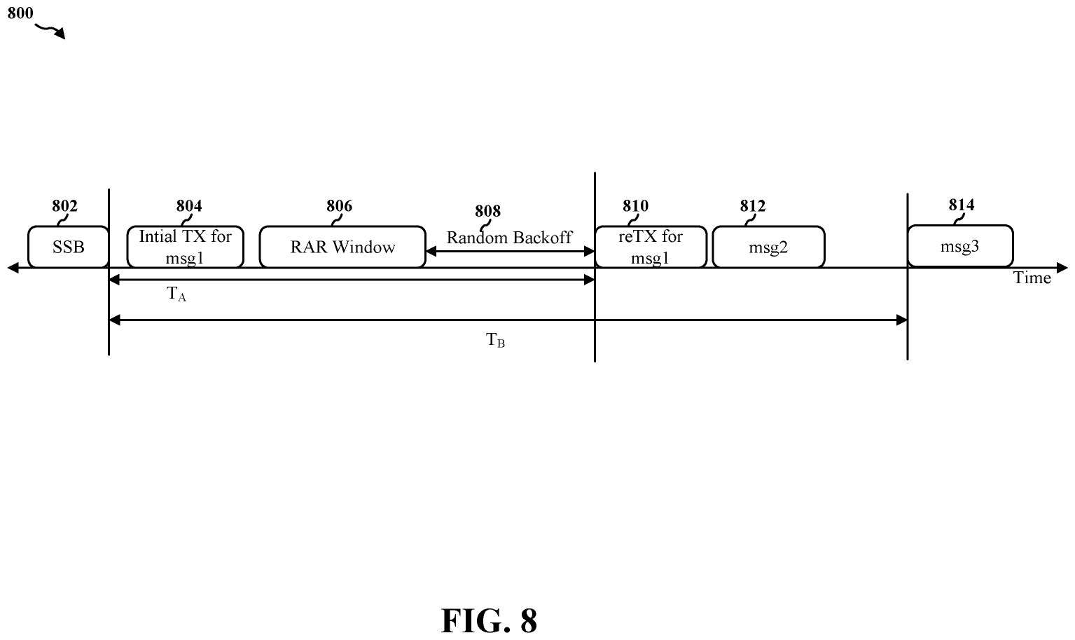

To meet timing error limit, a UE may measure the SSB of the serving cell at least once in the last N ms, such as the last 160 ms. In some aspects, N may have a default value of 160. In some aspects, N may be any positive value. When a UE performs a RA procedure or SDT procedure in an initial/non-initial BWP that does not include the SSB (e.g., such as the separate, e.g., first DL and UL BWP pair (DL BWP 562 and UL BWP 564 in FIG. 5)), although the UE may be within the UL timing error limit for the first transmission of msg 1, msg A, or CG-PUSCH, the subsequent UL (re-) transmissions may extend beyond 160 ms after a last measurement of the SSB due to collisions, coverage limitations and channel impairments. As an example, FIG. 8 is a diagram 800 illustrating timeline associated with 4-step RACH. As illustrated in FIG. 8, a UE, such as the UE described in connection with any of FIGS. 4-7 may receive SSB 802 (e.g., in the initial DL BWP 554). After receiving the SSB 802, the UE may change to a separate, e.g., first BWP pair (e.g., 562 and 564) for performing a random access procedure, the separate, e.g., first DL BWP not including the SSB from the serving cell. The UE may transmit a first transmission for msg 1 804 in the UL BWP 564. The random access response (RAR) window 806 may be scheduled for the UE to monitor for a RAR from the serving cell on the separate, e.g., first DL BWP 562 after transmitting the first transmission for msg 1 804 on the UL BWP 564. There may be a random back-off 808 between the RAR window 806 and another first transmission (e.g., a retransmission) of the msg 1 810. The time between the SSB and the retransmission of the msg 1 810 may be T_{A}. After retransmitting the msg 1 810 on the UL BWP 564, the UE may monitor for a msg 2 812 from a base station on the DL BWP 562. After receiving the msg 2 812 from the base station, the UE may accordingly transmit a msg 3 814 (e.g., on the UL BWP 564) in response. The time between the SSB and the msg 3 814 may be T_{B}. In a 4-step RACH procedure, T_{A} and/or T_{B} may be larger than 160 ms. In some aspects, if the initial/non-initial DL BWP of UE does not contain SSB or other DL RS (such as TRS) for time/frequency tracking and the RA/SDT procedure takes more than N ms to finish, the UE may retune and measure SSB or other DL RS outside the SSB-less initial/non-initial DL BWP configured with SS for RA and SDT. For example, the UE may switch from the DL BWP 562 or the UL BWP 564 to measure the SSB or DL RS on the BWP 554. The UE may then return the DL BWP 562 or the UL BWP 564 to continue the RA procedure or the SDT procedure. Aspects provided herein may provide synchronization procedures and signaling support for the situations where a UE is configured with an SSB-less initial/non-initial DL BWP for RA or SDT. An “SSB-less BWP” may refer to a DL BWP that does not include an SSB, e.g., that does not include an entire SSB that is transmitted by the serving cell.

In some aspects, when an RRC idle, inactive, or connected UE (that may be RedCap or non-RedCap) is configured with an SSB-less DL BWP for RA or SDT by system information (SI) or RRC, the SSB-less DL BWP may be configured with a CORESET and/or SS set for RA (for 2-step or 4-step RACH) or SDT (e.g., UL SDT based on RACH or configured grant such as RA-SDT or CG-SDT). In some aspects, the UE may expect its UL BWP (e.g., with the same BWP identifier (ID) as the SSB-less DL BWP) to include 1) valid PRACH occasions (e.g., ROs) for 4-step RACH and valid PUCCH resource sets for HARQ feedback of msg 4, 2) valid msg A PRACH/PUSCH occasions (msg A RO/PUSCH occasion) for 2-step RACH and valid PUCCH resource sets for HARQ feedback of msg B, or 3) valid SDT (e.g., RA-SDT or CG-SDT) occasions and valid PUCCH resource sets for HARQ feedback of SDT. In some aspects, the spatial relation (e.g., spatial relation information) for RO, msg A RO or PUSCH occasion, SDT occasions and PUCCH resource sets may be configured for a serving cell by the network, such as a base station. In some aspects, the spatial relation may be associated with a cell-defining (CD-SSB) or a non-cell defining (NCD)-SSB of a serving cell, which may be transmitted outside the SSB-less DL BWP configured for RA and SDT. In some aspects, the spatial relation may be associated with other DL RS of the serving cell (e.g. CSI-RS), which may be transmitted within or outside the SSB-less DL BWP configured for RA. In some aspects, the CORESET and/or SS set for RA procedure or SDT procedure may be quasi-co-located (QCLed) with the SSB or DL RS used for the spatial relation configuration. In some aspects, the CORESET and/or SS set for the RA procedure or the SDT procedure may be QCLed based on QCL type D. In some aspects, the SSB or DL RS configured as QCL source of the CORESET/SS for RA or SDT may also be used by UE for performing time and/or frequency synchronization during the RA or SDT procedure.

In some aspects, a QCL relationship may indicate a relationship between signals with respect to one or more of: a Doppler shift, a Doppler spread, an average delay, a delay spread, a set of spatial Rx parameters, or the like. In some aspects, the QCL relationship may be based on different QCL type parameter(s). There may be different types of QCL relationships, in which a QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters.

In some aspects, when a UE (e.g., a reduced capability UE or a regular UE) in an RRC idle, inactive, or connected state may be configured with an SSB-less DL BWP for RA or SDT procedure (such as small UL data transfer based on RACH or configured grant), the UE may be configured with the SSB-less DL BWP as part of a DL and UL pair by SI or RRC signal, and the SSB-less DL BWP may be configured with CORESET and/or SS set for RA (for 2-step or 4-step RACH) or SDT (e.g., RA-SDT or CG-SDT). SDT may refer to the exchange of DL/UL data from control plane or user plane below a size threshold that may be included in a paging message, RAR message, contention resolution message, or random access message of 4-step RACH or 2-step RACH, such as described in connection with FIG. 7 or transmitted in a configured grant resource for UEs without transitioning into an RRC connected state. In some aspects, after a UE initiates the RA procedure or the SDT procedure in the DL or UL BWP, the UE may start a retuning timer for DL BWP switching to measure SSB or other DL RS outside the SSB-less DL BWP. The UE may monitor the SSB-less DL BWP (e.g., 562) for a response to a RA message or SDT message transmitted in the UL (e.g., 564). In some aspects, the retuning timer and the timing advance (TA) timer for RA or SDT may be separately configured. In some aspects, the retuning timer configuration may be based at least on the UL timing accuracy requirement and UE capability. In some aspects, if configured by SI or RRC, the retuning timer may also depend on the periodicities/patterns of serving cell's CD-SSB/NCD-SSB/TRS/PRS/CSI-RS. In some aspects, the retuning timer tracks the time gap with regard to the last measurement occasion for SSB (or other DL RS) transmitted by the serving cell outside the SSB-less DL BWP for RA/SDT. In some aspects, a network may additionally configure a back-off parameter for msg 1 or msg A or SDT retransmission. In some aspects, the back-off parameter may be no less than UE's retuning delay and measurement gap. As an example, before msg 1 or msg A or SDT retransmission, the UE's timeline may be sufficient to measure SSB outside BWP to re-synchronize with the serving cell. In some aspects, when the retuning timer for RA/SDT (including RA-SDT and CG-SDT) expires, or the TA timer for RA/SDT (including RA-SDT and CG-SDT) expires, or the TA validation fails for (PUSCH/PUCCH/SRS transmission in) CG-SDT, the UE may autonomously (e.g., without signaling from base station) terminate its DL reception (e.g., on the separate initiate DL BWP 562) or cancel its UL transmission in the BWP (e.g., 564) configured for RA and SDT, where the DL termination or UL cancellation may be done fully or partially by UE. The UE may also switch or retune between BWPs to measure SSB or other DL RS, e.g., for time and/or frequency synchronization, or other layer-1 or layer-3 measurements required by power control, RA/SDT resource re-selection, mobility, radio resource management (RRM), radio link monitoring (RLM), beam management (such as BFR and BFD). In some other cases, the UE may need to switch or retune BWPs to receive system information update or notification for public warning system (PWS). In some aspects, the UE's timeline for BWP switching/retuning, DL termination (full or partial), UL cancellation (full or partial) and the effective length of measurement gap may depend at least on UE type or capability, SI modification period, interruption time for paging reception and the reference SCS of the active DL/UL BWP. In some aspects, after the measurement or the SI/PWS reception on the DL BWP 554 outside the SSB-less DL BWP 562 is done, the UE may retune back to the DL/UL BWPs 562 or 564, and resume the RA procedure or the SDT procedure. The UE may also reset the retuning timers.

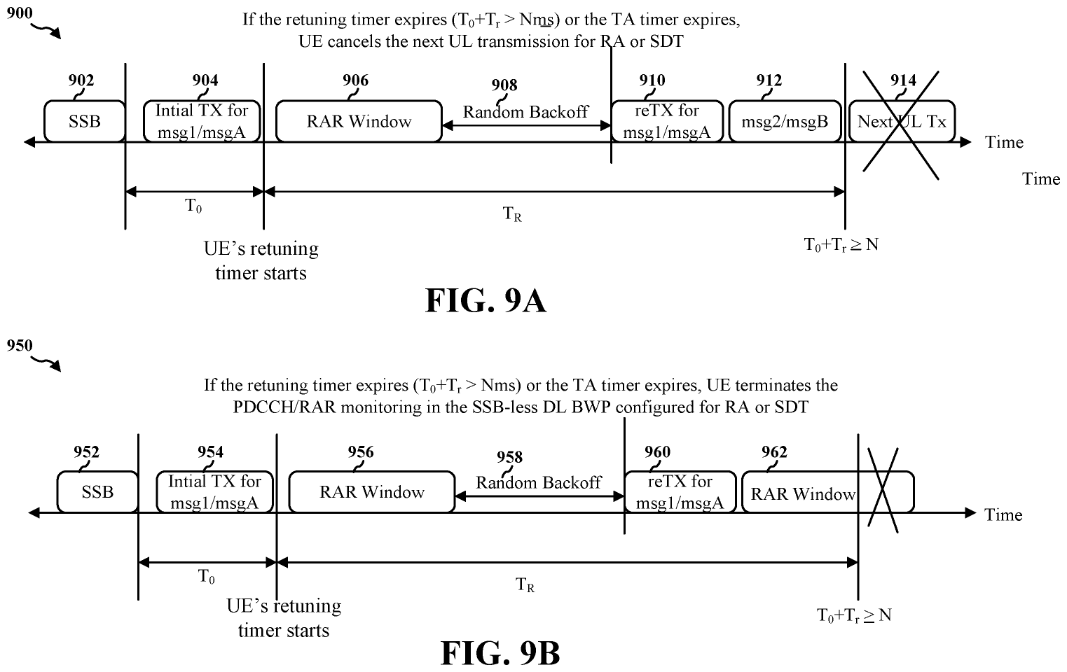

FIGS. 9A and 9B are diagrams 900 and 950 illustrating example timelines associated with retuning timers. As illustrated in FIG. 9A, a UE, such as the UE described in connection with any of FIGS. 4-7 may receive an SSB 902 (e.g., in an initial DL BWP 554). After receiving SSB 902, the UE may use a separate, e.g., first DL and UL BWP pair for random access. The UE may transmit an initial transmission of msg 1 (for four-step RACH) or msg A (for two-step RACH) at 904. The UE may monitor the DL BWP 562 during the RAR window 906 after transmitting the initial transmission the msg 1 or msg A 904. After the UE initiates RA or SDT in the UL BWP and after the initial transmission for msg 1 or msg A 904, the UE may start its retuning timer Tᵣ. The time between the SSB 902 and the starting of retuning timer may be T₀. There may be a random back-off 908 between the RAR window 906 and a retransmission of the msg 1 or msg A 910. After transmitting a retransmission of the msg 1 or msg A 910 on the UL BWP 564, the UE may monitor for a msg 2 or msg B 912 from a base station on the DL BWP 562. If the retuning timer expires (e.g., T₀+Tᵣ>N ms) or the TA timer expires, the UE may cancel the next UL transmission 914 for RA or SDT on the UL BWP 564 or DL reception on the DL BWP 562.

As illustrated in FIG. 9B, a UE, such as the UE described in connection with any of FIGS. 4-7 may switch to the DL BWP 554 to receive the SSB 952, e.g., based on the expiration of the timer. The UE may receive the SSB to perform synchronization measurements. After receiving SSB 952, the UE may transmit an initial transmission for msg 1 or msg A 954 on the UL BWP 564. The UE may monitor for a response from the base station on the DL BWP 562 during the RAR window 956 after receiving the initial transmission for msg 1 or msg A 954. After the UE initiates RA or SDT in the UL BWP 564 and after the initial transmission for msg 1 or msg A 954, the UE may start its retuning timer Tᵣ. The time between the SSB 952 and the starting of retuning timer may be T₀. There may be a random back-off 958 between the RAR window 956 and a retransmission of the msg 1 or msg A 960. After transmitting a retransmission of the msg 1 or msg A 960 in the UL BWP 564, the UE may monitor for a msg 2 or msg B in a RAR window 962 from a base station in the DL BWP 562. If the retuning timer expires (T₀+Tᵣ>Nms) or the TA timer expires, the UE may terminate the PDCCH/RAR (e.g., in RAR window 962) monitoring in the SSB-less DL BWP 562 configured for RA or SDT in order to switch to the DL BWP 554 to receive the SSB and to perform synchronization with the serving cell. In some aspects, the parameter Nms may be a number of milliseconds where the UE can continue the monitoring without measuring the SSB.

In some aspects, when an RRC idle, inactive, or connected UE is configured with an SSB-less DL BWP (e.g., 562) for RA or SDT by SI/RRC, the SSB-less DL BWP may be configured with CORESET/SS for RA (2-step or 4-step RACH) or SDT (RA-SDT or CG-SDT). In some aspects, after the UE initiates RA or SDT in the corresponding UL BWP (e.g., 564), the UE may start a retuning timer for DL BWP switching/retuning to measure SSB or other DL RS in the DL BWP 554 outside the SSB-less DL BWP 562. In addition, the UE may optionally report the retuning schedule (depending on the earlier expiration time of retuning timer and TA timer) in msg 3 or msg A PUSCH/CG PUSCH/UCI during the course of RA or SDT, if both RF retuning timer and TA timer are still running before the UL transmissions (i.e. msg 3 or msg A PUSCH/CG PUSCH/UCI) and the TA validation is successful for CG-PUSCH transmission. In some aspects, the UE may begin BWP retuning based on the retuning schedule reported to base station in msg 3 or msg A PUSCH/CG PUSCH/UCI, e.g., and may switch to the BWP 554 to perform synchronization after transmitting the reported value. In some aspects, UE's reporting for the retuning timer may be enabled/disabled by network in SI/RRC. For example, before performing the RA procedure or the SDT procedure, the UE may receive an indication from the base station enabling the timer report. When the UE initiates the RA or the SDT procedure in the BWP pair (e.g., 562 and 564), the UE may report the value of the timer to the base station. If the UE instead receives an indication that the timer value report is disabled, or does not receive an indication that the timer value report is enabled, the UE may refrain from reporting the timer value to the base station. In some aspects, UE's reporting for the retuning timer may be triggered by a condition or a triggering event. For example, the UE may be configured with one or more conditions or triggering events. If a condition or triggering event occurs, the UE may transmit the report of the timer value. For example, the UE may expect retuning before: the msg B RAR window expires, the msg4 contention resolution timer expires, or the TA timer expires, or the like. In some aspects, upon reception of UE's report of the retuning schedule, the base station may schedule subsequent DL channels (e.g. msg 4, msg B, DL feedback for SDT) or UL channels of UE (e.g. PUCCH for HARQ feedback) with a sufficient scheduling gap to accommodate UE's timeline extension due to retuning and measurement. In some aspects, after the measurement outside the SSB-less DL BWP is done, the UE may retune back to the original DL/UL BWPs, resume RA/SDT procedures, or reset retuning timer.

FIG. 10 is a diagram 1000 illustrating example timeline associated with retuning. As illustrated in FIG. 10, a UE, such as the UE described in connection with any of FIGS. 4-7 may receive SSB 1002. After receiving an SSB 1002 on DL BWP 554, the UE may transmit an initial transmission for msg 1 1004 in the UL BWP 564. After the UE initiates RA or SDT in the UL BWP 564 and after the initial transmission for msg 1 1004, the UE may start its retuning timer Tᵣ for DL BWP switching/retuning to measure SSB or other DL RS outside the SSB-less DL BWP. For example, after transmitting the msg 1 or msg A in the UL BWP 564, the UE may monitor the DL BWP 562 for a response from the bases station. The timer may relate to a time after which the UE switches from monitoring the DL BWP 562 for the response to the DL BWP 554 in order to receive the SSB. The time between the prior SSB 1002 reception and the start of the retuning timer may be T₀. After transmitting the initial transmission for msg 1 1004, the UE may monitor for a msg 2 1006 on the DL BWP 562. Based on an occurrence of one or more configured conditions or triggering events, UE may be triggered to report a retuning schedule in msg 3 1008. For example, based on a defined parameter τ, if N−τ<T₀+Tᵣ<N, the UE may be triggered to report retuning schedule in msg 3 1008. In some aspects, N may be a number of milliseconds after which the UE would no longer trust its timing as reliable if the UE have not measured the SSB in the last N milliseconds. The retuning schedule may refer to times at which the UE will return from the UL and DL BWP pair (DL BWP 562 and UL BWP 564) to the DL BWP 554 in order to perform synchronization by measuring the SSB or another DL reference signal. In some aspects, after transmitting the msg 3 1008, the UE may start retuning (e.g., may switch to the DL BWP 554) based on the retuning schedule reported in msg 3 1008. In some aspects, after finishing measurements for re-synchronization, the UE may return back to the BWP (e.g., 562 and/or 564) to continue the RA procedure or the SDT procedure. In some aspects, the time to return to the BWP 554 for synchronization measurements may lead to a delay in delivery (e.g., reception) of the msg 4 1010. In some aspects, a PUCCH 1012 may be transmitted after the msg 4 1010 is delivered.

FIG. 11 is a diagram 1100 illustrating an example timeline associated with BWP retuning for synchronization measurements (e.g. retuning from a separate initial BWP pair that does not include an SSB or DL reference signal to an initial DL BWP that does include the SSB or DL reference signal). As illustrated in FIG. 11, a UE, such as the UE described in connection with any of FIGS. 4-7 may receive an SSB 1102 in an initial DL BWP, such as the DL BWP 554. After receiving SSB 1102, the UE may transmit an initial transmission for msg 1 1104 to initiate a RA procedure or a SDT procedure. After the UE initiates RA or SDT in the UL BWP (e.g., 564) with the initial transmission for msg 1 1104, the UE may monitor an associated DL BWP for a reply from the base station (e.g., DL BWP 562). The UE may start its retuning timer Tᵣ for DL BWP switching/retuning to measure SSB or other DL RS in a DL BWP (e.g., 554) outside the SSB-less DL BWP (e.g., 562). The time between the SSB 1102 and the start of the retuning timer may be T₀. After transmitting the initial transmission for msg 1 1104, the UE may monitor the DL BWP 562 for a transmit a msg 2 1106. Based on an occurrence of one or more conditions or triggering events (e.g., which may be configured by the base station), the UE may be triggered to report a retuning schedule in msg 3. For example, based on a parameter t (which may be defined or otherwise known to the UE), if N−τT<T₀+Tᵣ<N, the UE may be triggered to report the retuning schedule in msg 3 1108. In some aspects, after receiving msg 4 1110 in response to the msg 3 1108, the UE may start returning (e.g., from DL BWP 562 to the DL BWP 554 to measure the SSB or other DL RS for synchronization) based on the retuning schedule reported in the msg 3 1108. In some aspects, after finishing measurements for re-synchronization, the UE may return back to the previous BWP (e.g., 562 or 564) to continue the RA procedure or the SDT procedure. In some aspects, the UE may transmit a PUCCH 1112, which may be delayed due to the retuning. The base station may be aware of the delayed timing for the PUCCH 1112 based on receiving the retuning schedule report from the UE.

In some aspects, when an RRC idle, inactive, or connected UE is configured with an SSB-less DL BWP (e.g., 562) for RA or SDT by SI/RRC, the SSB-less DL BWP 562 may be configured with CORESET/SS for RA (2-step or 4-step RACH) or SDT (RA-SDT or CG-SDT). In some aspects, after the UE initiates RA or SDT in a corresponding UL BWP (e.g., 564), the UE may monitor for a response in the DL BWP 562. The UE may also start a retuning timer for DL BWP switching or retuning to measure SSB or other DL RS outside the SSB-less DL BWP. In some aspects, the UE may also request for RAR window re-configuration based on early indication in msg 1 or msg A. In some aspects, the UE may begin retuning after transmitting the msg 1 or the msg A that includes the request. In some aspects, the UE's early indication of the request may be enabled/disabled by network in SI or RRC. For example, before performing the RA procedure or the SDT procedure, the UE may receive an indication from the base station enabling the request. When the UE initiates the RA or the SDT procedure in the BWP pair (e.g., 562 and 564), the UE may include the request to the base station. If the UE instead receives an indication that the request is disabled, or does not receive an indication that the request is enabled, the UE may refrain from sending the request to the base station. In some aspects, the UE's request for RAR window re-configuration may be triggered by configured conditions or events. In response to the occurrence of one or more condition or triggering event, which may be previously configured for the UE, the UE may transmit the request. For example, the UE may expect retuning for re-synchronization before the RAR window expires. In some aspects, upon transmission of the UE's early indication in msg 1 or msg A (including msg 1 or msg A transmission in RA-SDT), a base station may delay the delivery of msg 2 or msg B by a configured time offset to accommodate UE's timeline extension due to retuning and measurement outside the SSB-less DL BWP. In some aspects, after the measurement outside the SSB-less DL BWP is done, the UE may retune back to the original DL/UL BWPs (e.g., 562 and 564), resume RA/SDT procedures, and may reset the retuning timer.

FIG. 12 is a diagram 1200 illustrating an example timeline associated with retuning from a BWP pair with a DL BWP that does not include an SSB or other DL reference signal for synchronization to a DL BWP that includes an SSB or DL reference signal for synchronization. As illustrated in FIG. 12, a UE, such as the UE described in connection with any of FIGS. 4-7 may receive an SSB 1202, e.g., in DL BWP 554. After receiving SSB 1202, the UE may transmit an initial transmission for msg 1 or msg A 1204 in an UL BWP 564. The UE may then monitor for a response from the base station on DL BWP 562. After the UE initiates RA or SDT in the UL BWP 564 and after the initial transmission for msg 1 or msg A 1204, the UE may start its retuning timer Tᵣ for DL BWP switching/retuning to measure SSB or other DL RS outside the SSB-less DL BWP. The time between the reception of the SSB 1202 and the start of retuning timer may be T₀. The UE may monitor for a msg 2 or msg B response from the base station after a gap for msg 2 or msg B RAR window 1206, in a msg 2 or msg B RAR window 1208. After a random back-off 1210, the UE may be triggered to transmit a request for RAR window re-configuration to delay the delivery of msg B or msg 4. The UE may transmit the request based on an occurrence of one or more condition or triggering event, which may be configured for the UE by the base station. In some aspects, a msg A or msg 1 retransmission with an early indication 1212 may be transmitted by the UE to the base station. Upon reception of the UE's msg A or msg 1 retransmission with early indication 1212, the base station may delay the msg B or msg 2 RAR window 1218 and delivery of msg B or msg 2 1216 by a configured time offset 1214 to accommodate UE's timeline extension due to retuning and measurement outside the SSB-less DL BWP.

In some aspects, when an RRC idle, inactive, or connected UE is configured with an SSB-less DL BWP (e.g., 562) for RA or SDT by SI/RRC, the SSB-less DL BWP may be configured with CORESET/SS for RA (2-step or 4-step RACH) or SDT (RA-SDT or CG-SDT). In some aspects, after the UE initiates RA or SDT in UL BWP (e.g., 564), the UE may start a retuning timer for DL BWP switching or retuning to measure SSB or other DL RS outside the SSB-less DL BWP. The UE may monitor the DL BWP 562 for a response to the uplink message transmitted in the UL BWP 564. In some aspects, the UE may also request for a RS transmission or a RS configuration in the DL BWP 562 based on early indication in msg 1, msg 3, msg A, PUCCH, PUSCH, or other messages, for SDT. In some aspects, the UE may request a TRS, or another DL RS that the UE may use for synchronization. The transmission or configuration of the DL reference signal in the DL BWP 562 may allow the UE to continue to monitor the DL BWP 562 and to avoid retuning to the DL BWP 554 in order to perform synchronization. In some aspects, the UE's early indication may be enabled/disabled by network, e.g., through an indication or an absence of an indication in SI or RRC signaling. In some aspects, the UE's request for on-demand TRS transmission may be triggered by an occurrence of one or more condition or event. The conditions or triggering events may be configured by the base station for the UE. In some aspects, upon reception of UE's request or early indication in msg 1, msg 3, msg A, PUCCH, CG-PUSCH, or other messages, the base station may respond with ACK or NACK (e.g., in the DCI) for msg 2, msg B, or DL feedback for SDT. In some aspects, if the base station responds with an “ACK,” such as in DCI, the base station may acknowledge UE's request for on-demand transmission or configuration of the TRS. The UE may then monitor for the TRS in the DL BWP 562. The UE may expect to receive the TRS configuration in a MAC-CE associated with DCI. The UE may also expect to receive TRS in the SSB-less DL BWP without retuning. If the base station responds with “NACK” in DCI, the base station may decline UE's request for on-demand transmission or configuration of TRS. The UE may accordingly fall back to procedures based on retuning-timer to measure SSB or other DL RS outside the SSB-less DL BWP, e.g., if the timer expires, the UE may switch to the DL BWP 554 in order to perform synchronization based on the SSB or other DL reference signal.

FIG. 13 is a diagram 1300 illustrating example timeline associated with 2-step RACH. As illustrated in FIG. 13, after a base station transmits a DL transmission 1302 to a UE, there may be a gap 1304 greater than or equal to a defined parameter N_{gap} before a msg A 1306, which may include a preamble and a payload. Between the preamble and the payload, there may be a gap greater than or equal to a defined parameter N. After the start of msg B RAR window, which may be defined based on a first PDCCH symbol in the earliest SS for msg B PDCCH, there may be a msg B 1308 transmitted from the base station to the UE. The msg B 1308 may include a msg B PDCCH and a msg B PDSCH (based on success RAR). After a defined time 1310, the UE may transmit a PUCCH HARQ ACK/NACK 1312 to the base station.

FIG. 14 is a diagram 1400 illustrating example timeline associated with 4-step RACH. As illustrated in FIG. 14, after a base station transmit a DL channel or signal 1402 to a UE, there may be a gap 1404 equal to a defined gap N_{gap} before a msg 1 1406 may be transmitted. There may be a gap to a defined gap N after the msg 1 1406 and before a RAR window for a msg 2 associated with the msg 1 1406. After the start of the msg 2 RAR window, which may be defined based on a first PDCCH symbol in type-1 PDCCH SS for msg 2, there may be a msg 2 1408 transmitted from the base station to the UE. The msg 2 1408 may be associated with a PDCCH. After a defined time, msg 3 1410 may be transmitted from the UE to the base station. In response to the msg 3 1410, the base station may transmit a msg 4 1412 that may be associated with a PDCCH to the UE. The PDCCH may schedule resources for a PUCCH 1414. After an amount of time, the UE may transmit the PUCCH 1414 to the base station.

FIG. 15 is a flowchart 1500 of a method of wireless communication. The method may be performed by a UE (e.g., the UE 104, the UE 602, the UE 702; the apparatus 1704).

At 1502, the UE may receive a configuration for a first DL and UL BWP pair including information indicative of at least one of a CORESET, a SS set, and a set of UL resource occasions for a RA procedure or a SDT procedure. The first DL and UL BWP pair may include a first DL BWP and a first UL BWP. For example, the UE described in connection with any of FIGS. 4-14 may receive a configuration for a first DL and UL BWP pair including information indicative of at least one of a CORESET, a SS set, and a set of UL resource occasions for a RA procedure or a SDT procedure. In some aspects, 1502 may be performed by sync component 198. In some aspects, the first DL BWP does not include an entire SSB transmitted by the serving cell, and a QCL and a spatial relation configuration in the first DL and UL BWP pair is based on the SSB or the DL reference signal of the serving cell configured in the second DL BWP. In some aspects, the set of UL resource occasions in a first uplink BWP of the first DL and UL BWP pair is associated with (e.g., configured with) a spatial relation configuration with the SSB of the serving cell or the DL reference signal in the second DL BWP include one or more of: a RO for the RA procedure, a PUSCH occasion for the RA procedure, an SDT occasion based on random access or a configured grant, a SRS occasion, a PUCCH occasion associated with the RA procedure or the SDT. In some aspects, the configuration for the first DL and UL BWP pair includes information indicative of a CD-SSB or a NCD-SSB that is in the second DL BWP used for a QCL source, a spatial relation configuration and the synchronization of the UE performing the RA procedure or the SDT procedure in the first DL and UL BWP pair. In some aspects, the configuration for the first DL and UL BWP pair includes information indicative of a CSI-RS, a PRS, or TRS transmitted by serving cell in the second DL BWP and used for a spatial relation configuration and synchronization of the UE the RA procedure or the SDT procedure in a RRC idle, inactive or connected state. In some aspects, the CORESET and the SS set configured in the first DL BWP for the RA procedure or the SDT procedure has a QCL relationship to the SSB of the serving cell or the DL reference signal in the second DL BWP.

At 1504, the UE may initiate at least one of the RA procedure or the SDT procedure in the first DL and UL BWP pair. For example, the UE described in connection with any of FIGS. 4-14 may initiate at least one of the RA procedure or the SDT procedure in the first DL and UL BWP pair. In some aspects, 1504 may be performed by sync component 198.

At 1506, the UE may perform time or frequency synchronization during the RA procedure or the SDT procedure, using a SSB of a serving cell configured in a second DL BWP or a DL reference signal of the serving cell configured in the second DL BWP (e.g., or in a first DL BWP of the first DL and UL BWP pair). For example, the UE described in connection with any of FIGS. 4-14 may perform time or frequency synchronization during the RA procedure or the SDT procedure, using a SSB of a serving cell configured in a second DL BWP or a DL reference signal of the serving cell configured in the second DL BWP (e.g., or in a first DL BWP of the first DL and UL BWP pair). In some aspects, 1506 may be performed by sync component 198 in FIG. 17. In some aspects, performing the time or frequency synchronization includes suspending or canceling activities in the first DL BWP or a first UL BWP of the first DL and UL BWP pair during the RA procedure or the SDT procedure, switching from the first DL BWP or the first UL BWP to the second DL BWP to measure the SSB of the serving cell or the DL reference signal in the second DL BWP, returning from the second DL BWP to the first DL BWP or the first UL BWP following measurements of the SSB or the DL reference signal in the second DL BWP, using the measurements obtained in the second DL BWP for the time or frequency synchronization, power control, beam management, timing advance validation, or re-selection of uplink resource occasions, or resuming the RA procedure or the SDT procedure in the first DL and UL BWP pair. In some aspects, a timeline for switching from the first DL BWP or the first UL BWP to the second DL BWP is based on one or more of a capability supported by the UE, a device type indicated by the UE, a trigger event for BWP switching, or a reference SCS associated with the first DL BWP, the first UL BWP and the second DL BWP.

In some aspects the UE may also start, after initiating the RA procedure or the SDT procedure, a first timer associated with a BWP switch from the first DL BWP or the first UL BWP to the second DL BWP to measure the SSB or the DL reference signal (e.g., to meet UE's performance specification at least for synchronization, beam management and link maintenance), where the first timer tracks a gap relative to UE's latest measurement for the SSB or the DL reference signal of the serving cell. In some aspects, the UE may start, after initiating the RA procedure or the SDT procedure, a second timer associated with the RA procedure or the SDT procedure, which is separately configured from the first timer, where the UE switches from the first DL BWP or the first UL BWP to the second DL BWP, to measure the SSB or the DL reference signal in response to an expiration of the first timer or the second timer or a timing advance validation failure for the SDT procedure. In some aspects, the UE may reset the first timer after finishing measurement of the SSB or the DL reference signal in the second DL BWP.

In some aspects, switching from the first DL BWP or the first UL BWP to the second DL BWP further includes stopping downlink reception in the first DL BWP or uplink transmission in the first UL BWP. In some aspects, the UE may transmit, in one or multiple valid uplink resource occasions, a value of the first timer in a message during the RA procedure or the SDT procedure. In some aspects, the UE transmits the value of the first timer in the message based on the first timer and the second timer continuing to run or a successful timing advance validation for the SDT procedure. In some aspects, switching from the first DL BWP or the first UL BWP to the second DL BWP is performed following transmission of the value of the first timer or based on a BWP retuning schedule received from the serving cell in system information or a dedicated RRC message.

In some aspects, the UE may receive, prior to transmitting the message, signaling from the serving cell enabling a report of the value of the first timer, where the signaling is received in system information, a dedicated RRC message, a MAC CE or a DCI. In some aspects, the UE selectively transmits the value of the first timer in the message based on an occurrence of a condition or a trigger event depending at least on a UE capability, a type of the RA procedure or the SDT procedure, a cell coverage, or a frequency range. In some aspects, the UE may receive scheduling information for DL reception or UL transmission that includes a time offset in response to the value of the first timer reported by the UE, where the time offset provided by the serving cell is no less than a BWP switch delay and a measurement gap of the UE. In some aspects, the UE may transmit, in an uplink signal or channel (e.g. PRACH, PUSCH, PUCCH or SRS) associated with the RA procedure or the SDT procedure, a request for RAR window adjustment based on a BWP switch delay and a measurement gap of UE in the second DL BWP. In some aspects, switching from the first DL BWP or the first UL BWP to the second DL BWP is performed following transmission of the request, or based on a BWP retuning schedule received from the serving cell in system information or a dedicated RRC message. In some aspects, the UE may receive, prior to transmitting a random access message, signaling enabling the request for the RAR window adjustment from the UE, where the signaling is received from the serving cell in system information, a dedicated RRC message, a MAC CE or a DCI. In some aspects, the UE selectively transmits the request based on an occurrence of a condition or a trigger event, which depends on at least one of a UE capability, a type of the RA procedure or the SDT procedure, a cell coverage, or a frequency range. In some aspects, the UE may transmit, in an uplink signal or channel (e.g. PRACH, PUSCH, PUCCH or SRS) associated with the RA procedure or the SDT procedure, a request for an on-demand transmission of a NCD-SSB, TRS or other DL reference signal in the first DL BWP. In some aspects, the UE may receive, prior to transmitting the request, signaling from the serving cell enabling the request, where the signaling is received in system information, a dedicated RRC message, a MAC CE, or a DCI. In some aspects, the UE transmits the request based on an occurrence of a condition or a trigger event. In some aspects, the UE may receive an acknowledgement for the on-demand transmission of the NCD-SSB, the TRS, or the other DL reference signal, where performing the time or frequency synchronization includes measuring the NCD-SSB, the TRS or the other DL reference signal in the first DL BWP after receiving the acknowledgement. In some aspects, the UE may receive a negative response declining the request from the UE. In some aspects, the UE may switch from the first DL BWP or the first UL BWP to the second DL BWP to measure the SSB or the reference signal in the second DL BWP after receiving the negative response.

FIG. 16 is a flowchart 1600 of a method of wireless communication. The method may be performed by a base station (e.g., the base station 102/180, the base station 604, the base station 704; the apparatus 1802).

At 1602, the base station may transmit, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP. For example, the base station described in connection with any of FIGS. 4-14 may transmit, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP. In some aspects, 1602 may be performed by sync component 1842 in FIG. 18.

At 1604, the base station may receive an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair. For example, the base station described in connection with any of FIGS. 4-14 may receive an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair. In some aspects, 1604 may be performed by sync component 1842 in FIG. 18. In some aspects, the base station may receive, in the random access message or the SDT message, one of a value of a timer associated with a BWP switch from the first DL BWP or the first UL BWP to the second DL BWP for the UE to measure the SSB or the downlink reference signal of the serving cell or a second request for a RAR window adjustment based on a BWP switch delay and measurement gap to measure the SSB or the DL reference signal in the second DL BWP. In some aspects, the base station may schedule downlink transmission or uplink reception with the UE with a time offset for the BWP switch delay and the measurement gap of the UE to switch from the first DL BWP or the first UL BWP to the second DL BWP to measure the SSB or the DL reference signal. In some aspects, the base station may receive, in the random access message in the first UL BWP, a second request for on-demand transmission of a NCD-SSB, a TRS, or another DL reference signal in the first DL BWP. In some aspects, the base station may transmit, in response to the request, at least one of an acknowledgment and a reference signal configuration for one of the NCD-SSB, the TRS, or the other DL reference signal or a response message declining the second request.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, a satellite system module 1716 (e.g., GNSS module), one or more sensor modules 1718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the satellite system module 1716 may include an on-chip transceiver (TRX)/receiver (RX). The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described herein. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

In some aspects, the sync component 198 may be configured to receive a configuration for a first DL and UL BWP pair including information indicative of at least one of a CORESET, a SS set, and a set of UL resource occasions for a RA procedure or a SDT procedure. In some aspects, the sync component 198 may be further configured to initiate at least one of the RA procedure or the SDT procedure in the first DL and UL BWP pair. In some aspects, the sync component 198 may be further configured to perform time or frequency synchronization during the RA procedure or the SDT procedure, using a SSB of a serving cell configured in a second DL BWP or a DL reference signal of the serving cell configured in the second DL BWP (e.g., or in a first DL BWP of the first DL and UL BWP pair).

As shown, the apparatus 17041704 may include a variety of components configured for various functions. In one configuration, the apparatus 1704, and in particular the cellular baseband processor 1724, may include means for receiving a configuration for a first DL and UL BWP pair including information indicative of at least one of a CORESET, a SS set, and a set of UL resource occasions for a RA procedure or a SDT procedure. The cellular baseband processor 1724 may further include means for initiating at least one of the RA procedure or the SDT procedure in the first DL and UL BWP pair. The cellular baseband processor 1724 may further include means for performing time or frequency synchronization during the RA procedure or the SDT procedure, using a SSB of a serving cell configured in a second DL BWP or a DL reference signal of the serving cell configured in the second DL BWP (e.g., or in a first DL BWP of the first DL and UL BWP pair). The cellular baseband processor 1724 may further include means for suspending or canceling activities in the first DL BWP or a first UL BWP of the first DL and UL BWP pair during the RA procedure or the SDT procedure. The cellular baseband processor 1724 may further include means for switching from the first DL BWP or the first UL BWP to the second DL BWP to measure the SSB of the serving cell or the DL reference signal in the second DL BWP. The cellular baseband processor 1724 may further include means for returning from the second DL BWP to the first DL BWP or the first UL BWP following measurements of the SSB or the DL reference signal in the second DL BWP. The cellular baseband processor 1724 may further include means for using the measurements obtained in the second DL BWP for the time or frequency synchronization, power control, beam management, timing advance validation, or re-selection of uplink resource occasions. The cellular baseband processor 1724 may further include means for resuming the RA procedure or the SDT procedure in the first DL and UL BWP pair. The cellular baseband processor 1724 may further include means for starting, after initiating the RA procedure or the SDT procedure, a first timer associated with a BWP switch from the first DL BWP or the first UL BWP to the second DL BWP to measure the SSB or the DL reference signal, where the first timer tracks a gap relative to UE's latest measurement for the SSB or the DL reference signal of the serving cell. The cellular baseband processor 1724 may further include means for starting, after initiating the RA procedure or the SDT procedure, a second timer associated with the RA procedure or the SDT procedure, which is separately configured from the first timer, where the UE switches from the first DL BWP or the first UL BWP to the second DL BWP, to measure the SSB or the DL reference signal in response to an expiration of the first timer or the second timer or a timing advance validation failure for the SDT procedure. The cellular baseband processor 1724 may further include means for resetting the first timer after finishing measurement of the SSB or the DL reference signal in the second DL BWP. The cellular baseband processor 1724 may further include means for stopping downlink reception in the first DL BWP or uplink transmission in the first UL BWP. The cellular baseband processor 1724 may further include means for transmitting, in one or multiple valid uplink resource occasions, a value of the first timer in a message during the RA procedure or the SDT procedure. The cellular baseband processor 1724 may further include means for receiving, prior to transmitting the message, signaling from the serving cell enabling a report of the value of the first timer, where the signaling is received in system information, a dedicated RRC message, a MAC CE or a DCI. The cellular baseband processor 1724 may further include means for receiving scheduling information for DL reception or UL transmission that includes a time offset in response to the value of the first timer reported by the UE, where the time offset provided by the serving cell is no less than a BWP switch delay and a measurement gap of the UE. The cellular baseband processor 1724 may further include means for transmitting, in an uplink signal or channel associated with the RA procedure or the SDT procedure, a request for RAR window adjustment based on a BWP switch delay and a measurement gap of UE in the second DL BWP. The cellular baseband processor 1724 may further include means for receiving, prior to transmitting a random access message, signaling enabling the request for the RAR window adjustment from the UE, where the signaling is received from the serving cell in system information, a dedicated RRC message, a MAC CE or a DCI. The cellular baseband processor 1724 may further include means for transmitting, in an uplink signal or channel associated with the RA procedure or the SDT procedure, a request for an on-demand transmission of a NCD-SSB, TRS or other DL reference signal in the first DL BWP. The cellular baseband processor 1724 may further include means for receiving, prior to transmitting the request, signaling from the serving cell enabling the request, where the signaling is received in system information, a dedicated RRC message, a MAC CE, or a DCI. The cellular baseband processor 1724 may further include means for receiving an acknowledgement for the on-demand transmission of the NCD-SSB, the TRS, or the other DL reference signal, where performing the time or frequency synchronization includes measuring the NCD-SSB, the TRS or the other DL reference signal in the first DL BWP after receiving the acknowledgement. The cellular baseband processor 1724 may further include means for receiving a negative response declining the request from the UE. The cellular baseband processor 1724 may further include means for switching from the first DL BWP or the first UL BWP to the second DL BWP to measure the SSB or the reference signal in the second DL BWP after receiving the negative response. The means may be one or more of the components (e.g., component 198) of the apparatus 1704 configured to perform the functions recited by the means. As described supra, the apparatus 1704 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 18 is a diagram 1800 illustrating an example of a hardware implementation for an apparatus 1802. The apparatus 1802 may be a base station, a component of a base station, or may implement base station functionality. In some aspects, the apparatus 1704 may include a baseband unit 1804. The baseband unit 1804 may communicate through a cellular RF transceiver 1822 with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the base station 310 and may include the memory 376 and/or at least one of the TX processor 316, the RX processor 370, and the controller/processor 375.

The communication manager 1832 may include a sync component 1842 that may transmit, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP, e.g., as described in connection with 1602 in FIG. 16. The communication manager 1832 further may include a sync component 1842 that may receive an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair, e.g., as described in connection with 1604 in FIG. 16.

The apparatus may include additional components that perform each of the blocks of the algorithm in the flowchart of FIG. 16. As such, each block in the flowchart of FIG. 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the baseband unit 1804, may include means for transmitting, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP. The baseband unit 1804 may further include means for receiving an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair. The baseband unit 1804 may further include means for scheduling downlink transmission or uplink reception with the UE with a time offset for the BWP switch delay and the measurement gap of the UE to switch from the first DL BWP or the first UL BWP to the second DL BWP to measure the SSB or the DL reference signal. The baseband unit 1804 may further include means for receiving, in the random access message in the first UL BWP, a second request for on-demand transmission of a NCD-SSB, a TRS, or another DL reference signal in the first DL BWP. The baseband unit 1804 may further include means for transmitting, in response to the request, at least one of an acknowledgment and a reference signal configuration for one of the NCD-SSB, the TRS, or the other DL reference signal, or a response message declining the second request. The means may be one or more of the components of the apparatus 1802 configured to perform the functions recited by the means. As described supra, the apparatus 1802 may include the TX Processor 316, the RX Processor 370, and the controller/processor 375. As such, in one configuration, the means may be the TX Processor 316, the RX Processor 370, and the controller/processor 375 configured to perform the functions recited by the means.

FIG. 19 is a diagram 1900 illustrating an example of a wireless communications system and an access network. The illustrated wireless communications system includes a disaggregated base station architecture. The disaggregated base station architecture may include one or more CUs 1910 that can communicate directly with a core network 1920 via a backhaul link, or indirectly with the core network 1920 through one or more disaggregated base station units (such as a Near-Real Time (Near-RT) RAN Intelligent Controller (RIC) 1925 via an E2 link, or a Non-Real Time (Non-RT) RIC 1915 associated with a Service Management and Orchestration (SMO) Framework 1905, or both). A CU 1910 may communicate with one or more DUs 1930 via respective midhaul links, such as an F1 interface. The DUs 1930 may communicate with one or more RUs 1940 via respective fronthaul links. The RUs 1940 may communicate with respective UEs 1904 via one or more radio frequency (RF) access links. In some implementations, the UE 1904 may be simultaneously served by multiple RUs 1940.

Each of the units, i.e., the CUS 1910, the DUs 1930, the RUs 1940, as well as the Near-RT RICs 1925, the Non-RT RICs 1915, and the SMO Framework 1905, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 1910 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1910. The CU 1910 may be configured to handle user plane functionality (i.e., Central Unit-User Plane (CU-UP)), control plane functionality (i.e., Central Unit-Control Plane (CU-CP)), or a combination thereof. In some implementations, the CU 1910 can be logically split into one or more CU-UP units and one or more CU-CP units. The CU-UP unit can communicate bidirectionally with the CU-CP unit via an interface, such as an E1 interface when implemented in an O-RAN configuration. The CU 1910 can be implemented to communicate with the DU 1930, as necessary, for network control and signaling.

The DU 1930 may correspond to a logical unit that includes one or more base station functions to control the operation of one or more RUs 1940. In some aspects, the DU 1930 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 1930 may further host one or more low PHY layers. Each layer (or module) can be implemented with an interface configured to communicate signals with other layers (and modules) hosted by the DU 1930, or with the control functions hosted by the CU 1910.

Lower-layer functionality can be implemented by one or more RUs 1940. In some deployments, an RU 1940, controlled by a DU 1930, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based on the functional split, such as a lower layer functional split. In such an architecture, the RU(s) 1940 can be implemented to handle over the air (OTA) communication with one or more UEs 1904. In some implementations, real-time and non-real-time aspects of control and user plane communication with the RU(s) 1940 can be controlled by the corresponding DU 1930. In some scenarios, this configuration can enable the DU(s) 1930 and the CU 1910 to be implemented in a cloud-based RAN architecture, such as a vRAN architecture.

The SMO Framework 1905 may be configured to support RAN deployment and provisioning of non-virtualized and virtualized network elements. For non-virtualized network elements, the SMO Framework 1905 may be configured to support the deployment of dedicated physical resources for RAN coverage requirements that may be managed via an operations and maintenance interface (such as an O1 interface). For virtualized network elements, the SMO Framework 1905 may be configured to interact with a cloud computing platform (such as an open cloud (O-Cloud) 1990) to perform network element life cycle management (such as to instantiate virtualized network elements) via a cloud computing platform interface (such as an O2 interface). Such virtualized network elements can include, but are not limited to, CUs 1910, DUs 1930, RUs 1940 and Near-RT RICs 1925. In some implementations, the SMO Framework 1905 can communicate with a hardware aspect of a 4G RAN, such as an open eNB (O-eNB) 1911, via an O1 interface. Additionally, in some implementations, the SMO Framework 1905 can communicate directly with one or more RUs 1940 via an O1 interface. The SMO Framework 1905 also may include a Non-RT RIC 1915 configured to support functionality of the SMO Framework 1905.

The Non-RT RIC 1915 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 1925. The Non-RT RIC 1915 may be coupled to or communicate with (such as via an A1 interface) the Near-RT RIC 1925. The Near-RT RIC 1925 may be configured to include a logical function that enables near-real-time control and optimization of RAN elements and resources via data collection and actions over an interface (such as via an E2 interface) connecting one or more CUs 1910, one or more DUs 1930, or both, as well as an O-eNB, with the Near-RT RIC 1925.

In some implementations, to generate AI/ML models to be deployed in the Near-RT RIC 1925, the Non-RT RIC 1915 may receive parameters or external enrichment information from external servers. Such information may be utilized by the Near-RT RIC 1925 and may be received at the SMO Framework 1905 or the Non-RT RIC 1915 from non-network data sources or from network functions. In some examples, the Non-RT RIC 1915 or the Near-RT RIC 1925 may be configured to tune RAN behavior or performance. For example, the Non-RT RIC 1915 may monitor long-term trends and patterns for performance and employ AI/ML models to perform corrective actions through the SMO Framework 1905 (such as reconfiguration via 01) or via creation of RAN management policies (such as A1 policies).

At least one of the CU 1910, the DU 1930, and the RU 1940 may be referred to as a base station 1902. Accordingly, a base station 1902 may include one or more of the CU 1910, the DU 1930, and the RU 1940 (each component indicated with dotted lines to signify that each component may or may not be included in the base station 1902). The base station 1902 provides an access point to the core network 1920 for a UE 1904. The base stations 1902 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 1940 and the UEs 1904 may include uplink (UL) (also referred to as reverse link) transmissions from a UE 1904 to an RU 1940 and/or downlink (DL) (also referred to as forward link) transmissions from an RU 1940 to a UE 1904. The communication links may use multiple-input and multiple-output (MIMO) antenna technology, including spatial multiplexing, beamforming, and/or transmit diversity. The communication links may be through one or more carriers. The base stations 1902/UEs 1904 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 1904 may communicate with each other using device-to-device (D2D) communication link 1958. The D2D communication link 1958 may use the DL/UL wireless wide area network (WWAN) spectrum. The D2D communication link 1958 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 1950 in communication with UEs 1904 (also referred to as Wi-Fi stations (STAs)) via communication link 1954, e.g., in a 5 GHz unlicensed frequency spectrum or the like. When communicating in an unlicensed frequency spectrum, the UEs 1904/AP 1950 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-1914.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 1902 and the UE 1904 may each include a plurality of antennas, such as antenna elements, antenna panels, and/or antenna arrays to facilitate beamforming. The base station 1902 may transmit a beamformed signal 1982 to the UE 1904 in one or more transmit directions. The UE 1904 may receive the beamformed signal from the base station 1902 in one or more receive directions. The UE 1904 may also transmit a beamformed signal 1984 to the base station 1902 in one or more transmit directions. The base station 1902 may receive the beamformed signal from the UE 1904 in one or more receive directions. The base station 1902/UE 1904 may perform beam training to determine the best receive and transmit directions for each of the base station 1902/UE 1904. The transmit and receive directions for the base station 1902 may or may not be the same. The transmit and receive directions for the UE 1904 may or may not be the same.

The base station 1902 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 1902 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 1920 may include an Access and Mobility Management Function (AMF) 1961, a Session Management Function (SMF) 1962, a User Plane Function (UPF) 1963, a Unified Data Management (UDM) 1964, one or more location servers 1968, and other functional entities. The AMF 1961 is the control node that processes the signaling between the UEs 1904 and the core network 1920. The AMF 1961 supports registration management, connection management, mobility management, and other functions. The SMF 1962 supports session management and other functions. The UPF 1963 supports packet routing, packet forwarding, and other functions. The UDM 1964 supports the generation of authentication and key agreement (AKA) credentials, user identification handling, access authorization, and subscription management. The one or more location servers 1968 are illustrated as including a Gateway Mobile Location Center (GMLC) 1965 and a Location Management Function (LMF) 1966. However, generally, the one or more location servers 1968 may include one or more location/positioning servers, which may include one or more of the GMLC 1965, the LMF 1966, a position determination entity (PDE), a serving mobile location center (SMLC), a mobile positioning center (MPC), or the like. The GMLC 1965 and the LMF 1966 support UE location services. The GMLC 1965 provides an interface for clients/applications (e.g., emergency services) for accessing UE positioning information. The LMF 1966 receives measurements and assistance information from the NG-RAN and the UE 1904 via the AMF 1961 to compute the position of the UE 1904. The NG-RAN may utilize one or more positioning methods in order to determine the position of the UE 1904. Positioning the UE 1904 may involve signal measurements, a position estimate, and an optional velocity computation based on the measurements. The signal measurements may be made by the UE 1904 and/or the serving base station 1902. The signals measured may be based on one or more of a satellite positioning system (SPS) 1970 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 1904 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 1904 may be referred to as IoT devices (e.g., parking meter, gas pump, toaster, vehicles, heart monitor, etc.). The UE 1904 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 19, in some aspects, the UE 1904 may include a sync component 1998. In some aspects, the sync component 1998 may be configured to receive a configuration for a first DL and UL BWP pair including information indicative of at least one of a CORESET, a SS set, and a set of UL resource occasions for a RA procedure or a SDT procedure. In some aspects, the sync component 1998 may be further configured to initiate at least one of the RA procedure or the SDT procedure in the first DL and UL BWP pair. In some aspects, the sync component 1998 may be further configured to perform time or frequency synchronization during the RA procedure or the SDT procedure, using a SSB of a serving cell configured in a second DL BWP or a DL reference signal of the serving cell configured in the second DL BWP (e.g., or in a first DL BWP of the first DL and UL BWP pair).

In some aspects, the base station 102 may include a sync component 1999. In some aspects, the sync component 1999 may be configured to transmit, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP. In some aspects, the sync component 1999 may be further configured to receive an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair. FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

In some aspects, the sync component 199 may be configured to transmit, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP. In some aspects, the sync component 199 may be further configured to receive an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair . . . . The sync component 199 may be within one or more processors of one or more of the CU 2010, DU 2030, and the RU 2040. The sync component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. The network entity 2002 may include means for transmitting, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP. The network entity 2002 may further include means for receiving an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair. The network entity 2002 may further include means for scheduling downlink transmission or uplink reception with the UE with a time offset for the BWP switch delay and the measurement gap of the UE to switch from the first DL BWP or the first UL BWP to the second DL BWP to measure the SSB or the DL reference signal. The network entity 2002 may further include means for receiving, in the random access message in the first UL BWP, a second request for on-demand transmission of a NCD-SSB, a TRS, or another DL reference signal in the first DL BWP. The network entity 2002 may further include means for transmitting, in response to the request, at least one of an acknowledgment and a reference signal configuration for one of the NCD-SSB, the TRS, or the other DL reference signal, or a response message declining the second request. The means may be the sync component 199 of the network entity 2002 configured to perform the functions recited by the means. As described herein, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving a configuration for a first DL and UL BWP pair including information indicative of at least one of a CORESET, a SS set, and a set of UL resource occasions for a RA procedure or a SDT procedure, the first DL and UL BWP pair including a first DL BWP and a first UL BWP; initiating at least one of the RA procedure or the SDT procedure in the first DL and UL BWP pair; and performing time or frequency synchronization during the RA procedure or the SDT procedure, using a SSB of a serving cell configured in a second DL BWP or a DL reference signal of the serving cell configured in the second DL BWP.

Aspect 2 is the method of aspect 1, where the first DL BWP does not include an entire SSB transmitted by the serving cell, and a QCL and a spatial relation configuration in the first DL and UL BWP pair is based on the SSB or the DL reference signal of the serving cell configured in the second DL BWP.

Aspect 3 is the method of any of aspects 1-2, where the set of UL resource occasions in a first uplink BWP of the first DL and UL BWP pair is associated with (e.g., configured with) a spatial relation configuration with the SSB of the serving cell or the DL reference signal in the second DL BWP include one or more of: a RO for the RA procedure, a PUSCH occasion for the RA procedure, an SDT occasion based on random access or a configured grant, a SRS occasion, or a PUCCH occasion associated with the RA procedure or the SDT.

Aspect 4 is the method of any of aspects 1-3, where the configuration for the first DL and UL BWP pair includes information indicative of a CD-SSB or a NCD-SSB that is in the second DL BWP used for (e.g., used as) a QCL source, a spatial relation configuration and the synchronization of the UE performing the RA procedure or the SDT procedure in the first DL and UL BWP pair. In some aspects, the spatial relation configuration for the NCD-SSB and the CD-SSB may be the same because the NCD-SSB and the CD-SSB may share a same ssb-positioninBurst information element (IE).

Aspect 5 is the method of any of aspects 1-4, where the configuration for the first DL and UL BWP pair includes information indicative of a CSI-RS, a PRS, or TRS transmitted by serving cell in the second DL BWP and used for a spatial relation configuration and synchronization of the UE the RA procedure or the SDT procedure in a RRC idle, inactive or connected state.

Aspect 6 is the method of any of aspects 1-5, where the CORESET and the SS set configured in the first DL BWP for the RA procedure or the SDT procedure has a QCL relationship to the SSB of the serving cell or the DL reference signal in the second DL BWP.

Aspect 7 is the method of any of aspects 1-6, where performing the time or frequency synchronization includes: suspending or stopping communications in the first DL BWP or a first UL BWP of the first DL and UL BWP pair during the RA procedure or the SDT procedure; switching from the first DL BWP or the first UL BWP to the second DL BWP to measure the SSB of the serving cell or the DL reference signal in the second DL BWP; returning from the second DL BWP to the first DL BWP or the first UL BWP following measurements of the SSB or the DL reference signal in the second DL BWP; using the measurements obtained in the second DL BWP for the time or frequency synchronization, power control, beam management, timing advance validation, or re-selection of uplink resource occasions; and resuming or restarting communications during the RA procedure or the SDT procedure in the first DL and UL BWP pair.

Aspect 8 is the method of any of aspects 1-7, where a timeline for switching from the first DL BWP or the first UL BWP to the second DL BWP is based on one or more of a capability supported by the UE, a device type indicated by the UE, a trigger event for BWP switching, or a reference SCS associated with the first DL BWP, the first UL BWP and the second DL BWP.

Aspect 9 is the method of any of aspects 1-8, further comprising: starting, after initiating the RA procedure or the SDT procedure, a first timer associated with a BWP switch from the first DL BWP or the first UL BWP to the second DL BWP to measure the SSB or the DL reference signal, where the first timer tracks a gap relative to UE's latest measurement for the SSB or the DL reference signal of the serving cell; starting, after initiating the RA procedure or the SDT procedure, a second timer (e.g., which may correspond to a cg-SDT-TimeAlignmentTimerCommon information element or a TimeAlignmentTimer information element) associated with the RA procedure or the SDT procedure, which is separately configured from the first timer, where the UE switches from the first DL BWP or the first UL BWP to the second DL BWP, to measure the SSB or the DL reference signal in response to an expiration of the first timer or the second timer or a timing advance validation failure for the SDT procedure; and resetting the first timer after finishing measurement of the SSB or the DL reference signal in the second DL BWP.

Aspect 10 is the method of any of aspects 1-9, where switching from the first DL BWP or the first UL BWP to the second DL BWP further includes: stopping downlink reception in the first DL BWP or uplink transmission in the first UL BWP.

Aspect 11 is the method of any of aspects 1-10, further comprising: transmitting, in one or multiple valid uplink resource occasions, a value of the first timer in a message during the RA procedure or the SDT procedure.

Aspect 12 is the method of any of aspects 1-11, where the UE transmits the value of the first timer in the message based on the first timer and the second timer continuing to run or a successful timing advance validation for the SDT procedure.

Aspect 13 is the method of any of aspects 1-12, where switching from the first DL BWP or the first UL BWP to the second DL BWP is performed following transmission of the value of the first timer or based on a BWP retuning schedule received from the serving cell in system information or a dedicated RRC message.

Aspect 14 is the method of any of aspects 1-13, further comprising: receiving, prior to transmitting the message, signaling from the serving cell enabling a report of the value of the first timer (e.g., which may correspond to a ue-TimerAndConstants information element), where the signaling is received (e.g., in SIB 1) in system information, a dedicated RRC message, a MAC CE or a DCI.

Aspect 15 is the method of any of aspects 1-14, where the UE selectively transmits the value of the first timer in the message based on an occurrence of a condition or a trigger event depending at least on a UE capability, a type of the RA procedure or the SDT procedure, a cell coverage, or a frequency range.

Aspect 16 is the method of any of aspects 1-15, further comprising: receiving scheduling information for DL reception or UL transmission that includes a time offset in response to the value of the first timer reported by the UE, where the time offset provided by the serving cell is no less than a BWP switch delay and a measurement gap of the UE.

Aspect 17 is the method of any of aspects 1-16, further comprising: transmitting, in an uplink signal or channel associated with the RA procedure or the SDT procedure, a request for RAR window adjustment based on a BWP switch delay and a measurement gap of UE in the second DL BWP.

Aspect 18 is the method of any of aspects 1-17, where switching from the first DL BWP or the first UL BWP to the second DL BWP is performed following transmission of the request, or based on a BWP retuning schedule received from the serving cell in system information or a dedicated RRC message.

Aspect 19 is the method of any of aspects 1-18, further comprising: receiving, prior to transmitting a random access message, signaling enabling the request for the RAR window adjustment from the UE, where the signaling is received from the serving cell in system information, a dedicated RRC message, a MAC CE or a DCI.

Aspect 20 is the method of any of aspects 1-19, where the UE selectively transmits the request based on an occurrence of a condition or a trigger event, which depends on at least one of a UE capability, a type of the RA procedure or the SDT procedure, a cell coverage, or a frequency range.

Aspect 21 is the method of any of aspects 1-20, further comprising: transmitting, in an uplink signal or channel associated with the RA procedure or the SDT procedure, a request for an on-demand transmission of a NCD-SSB, TRS or other DL reference signal in the first DL BWP.

Aspect 22 is the method of any of aspects 1-21, further comprising: receiving, prior to transmitting the request, signaling from the serving cell enabling the request, where the signaling is received in system information, a dedicated RRC message, a MAC CE, or a DCI.

Aspect 23 is the method of any of aspects 1-22, where the UE transmits the request based on an occurrence of a condition or a trigger event.

Aspect 24 is the method of any of aspects 1-23, further comprising: receiving an acknowledgement for the on-demand transmission of the NCD-SSB, the TRS, or the other DL reference signal, where performing the time or frequency synchronization includes measuring the NCD-SSB, the TRS or the other DL reference signal in the first DL BWP after receiving the acknowledgement.

Aspect 25 is the method of any of aspects 1-24, further comprising: receiving a negative response declining the request from the UE; and switching from the first DL BWP or the first UL BWP to the second DL BWP to measure the SSB or the reference signal in the second DL BWP after receiving the negative response.

Aspect 26 is a method of wireless communication at a base station (e.g., network node), comprising: transmitting, to a UE in a RRC idle, inactive or connected state, a configuration for random access procedure or a SDT procedure in a first downlink and uplink BWP pair, including information indicative of at least one of a CORESET, a SS set, a set of uplink resource occasions for the random access procedure or the SDT procedure, and a SSB or DL reference signal in a second DL BWP, where a first DL BWP of the first DL and UL BWP pair does not include the SSB, and a QCL source, a spatial relation configuration and synchronization for the UE during the random access procedure or the SDT procedure are based on the SSB or the DL reference signal transmitted by a serving cell in the second DL BWP; and
receiving an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair.

Aspect 27 is the method of aspect 26, further comprising receiving, in the random access message or the SDT message, one of: a value of a timer associated with a BWP switch from the first DL BWP or the first UL BWP to the second DL BWP for the UE to measure the SSB or the downlink reference signal of the serving cell, or a second request for a RAR window adjustment based on a BWP switch delay and measurement gap to measure the SSB or the DL reference signal in the second DL BWP, the method further comprising: scheduling downlink transmission or uplink reception with the UE with a time offset for the BWP switch delay and the measurement gap of the UE to switch from the first DL BWP or the first UL BWP to the second DL BWP to measure the SSB or the DL reference signal.

Aspect 28 is the method of any of aspects 26-27, further comprising: receiving, in the random access message in the first UL BWP, a second request for on-demand transmission of a NCD-SSB, a TRS, or another DL reference signal in the first DL BWP; and transmitting, in response to the request, at least one of: an acknowledgment and a reference signal configuration for one of the NCD-SSB, the TRS, or the other DL reference signal, or a response message declining the second request.

Aspect 29 is an apparatus for wireless communication including information indicative of at least one processor coupled to a memory and configured to perform the method of any of aspects 1 to 25.

Aspect 30 is an apparatus for wireless communication including information indicative of at least one processor coupled to a memory and configured to perform the method of any of aspects 26 to 28.

Aspect 31 is an apparatus for wireless communication including means for performing the method of any of aspects 1 to 25.

Aspect 32 is an apparatus for wireless communication including means for performing the method of any of aspects 26 to 28.

Aspect 33 is a computer-readable medium storing computer executable code, where the code when executed by a processor causes the processor to perform the method of any of aspects 1 to 25.

Aspect 34 is a computer-readable medium storing computer executable code, where the code when executed by a processor causes the processor to perform the method of any of aspects 26 to 28.

What is claimed is:

1. An apparatus for wireless communication at a user equipment (UE), comprising:
a memory; and
at least one processor coupled to the memory and configured to:
receive a configuration for a first downlink (DL) and uplink (UL) bandwidth part (BWP) pair including information indicative of at least one of a control resource set (CORESET), a search space (SS) set, and a set of UL resource occasions for a random access (RA) procedure or a small data transmission (SDT) procedure, the first DL and UL BWP pair including a first DL BWP and a first UL BWP;
initiate at least one of the RA procedure or the SDT procedure in the first DL and UL BWP pair; and
perform time or frequency synchronization during the RA procedure or the SDT procedure, using a synchronization signal block (SSB) of a serving cell configured in a second DL BWP or a DL reference signal of the serving cell configured in the second DL BWP.

2. The apparatus of claim 1, wherein the first DL BWP does not include an entire SSB transmitted by the serving cell, and a quasi-colocation (QCL) and a spatial relation configuration in the first DL and UL BWP pair is based on the SSB or the DL reference signal of the serving cell configured in the second DL BWP.

3. The apparatus of claim 1, wherein the set of UL resource occasions in a first uplink BWP of the first DL and UL BWP pair is associated with a spatial relation configuration with the SSB of the serving cell or the DL reference signal in the second DL BWP include one or more of:
a physical random access channel (PRACH) occasion (RO) for the RA procedure,
a physical uplink shared channel (PUSCH) occasion for the RA procedure,
an SDT occasion based on random access or a configured grant,
a sounding reference signal (SRS) occasion, or
a physical uplink control channel (PUCCH) occasion associated with the RA procedure or the SDT procedure.

4. The apparatus of claim 1, wherein the configuration for the first DL and UL BWP pair includes information indicative of a cell defining SSB (CD-SSB) or a non-cell defining SSB (NCD-SSB) that is in the second DL BWP and used for a quasi-colocation (QCL) source, a spatial relation configuration, and a reference signal for the synchronization of the UE performing the RA procedure or the SDT procedure in the first DL and UL BWP pair.

5. The apparatus of claim 1, wherein the configuration for the first DL and UL BWP pair includes information indicative of a channel state information reference signal (CSI-RS), a positioning reference signal (PRS), or tracking reference signal (TRS) transmitted by serving cell in the second DL BWP and used for a spatial relation configuration and synchronization of the UE the RA procedure or the SDT procedure in a radio resource control (RRC) idle, inactive or connected state.

6. The apparatus of claim 1, wherein the CORESET and the SS set configured in the first DL BWP for the RA procedure or the SDT procedure has a quasi co-location (QCL) relationship to the SSB of the serving cell or the DL reference signal in the second DL BWP.

7. The apparatus of claim 1, wherein to perform the time or frequency synchronization, the at least one processor is further configured to:
suspend or stop communications in the first DL BWP or a first UL BWP of the first DL and UL BWP pair during the RA procedure or the SDT procedure;
switch from the first DL BWP or the first UL BWP to the second DL BWP to measure the SSB of the serving cell or the DL reference signal in the second DL BWP;
switch back from the second DL BWP to the first DL BWP or the first UL BWP following measurements of the SSB or the DL reference signal in the second DL BWP;
use the measurements in the second DL BWP for the time or frequency synchronization, power control, beam management, timing advance validation, or re-selection of uplink resource occasions; and
resume or restart communications during the RA procedure or the SDT procedure in the first DL and UL BWP pair.

8. The apparatus of claim 7, wherein a timeline for switching from the first DL BWP or the first UL BWP to the second DL BWP is based on one or more of a capability supported by the UE, a device type indicated by the UE, a trigger event for BWP switching, or a reference subcarrier spacing (SCS) associated with the first DL BWP, the first UL BWP and the second DL BWP.

9. The apparatus of claim 7, wherein the at least one processor is further configured to:
start, after initiating the RA procedure or the SDT procedure, a first timer associated with a BWP switch from the first DL BWP or the first UL BWP to the second DL BWP to measure the SSB or the DL reference signal, wherein the first timer tracks a gap relative to UE's latest measurement for the SSB or the DL reference signal of the serving cell;
start, after initiating the RA procedure or the SDT procedure, a second timer associated with the RA procedure or the SDT procedure, which is separately configured from the first timer, wherein the UE switches from the first DL BWP or the first UL BWP to the second DL BWP, to measure the SSB or the DL reference signal in response to an expiration of the first timer or the second timer or a timing advance validation failure for the SDT procedure; and
reset the first timer after finishing measurement of the SSB or the DL reference signal in the second DL BWP.

10. The apparatus of claim 9, wherein to switch from the first DL BWP or the first UL BWP to the second DL BWP, the at least one processor is further configured to:
stop downlink reception in the first DL BWP or uplink transmission in the first UL BWP.

11. The apparatus of claim 9, wherein the at least one processor is further configured to:
transmit, in one or multiple UL resource occasions, a value of the first timer in a message during the RA procedure or the SDT procedure.

12. The apparatus of claim 11, the at least one processor is further configured to transmit the value of the first timer in the message based on determining that the first timer and the second timer are running.

13. The apparatus of claim 11, wherein to switch from the first DL BWP or the first UL BWP to the second DL BWP, the at least one processor is further configured to: switch from the first DL BWP or the first UL BWP to the second DL BWP following transmission of the value of the first timer or based on a BWP retuning schedule received from the serving cell in system information or a dedicated radio resource control (RRC) message.

14. The apparatus of claim 11, wherein the at least one processor is further configured to:
receive, prior to transmitting the message, signaling from the serving cell enabling a report of the value of the first timer, wherein the signaling is received in system information, a dedicated radio resource control (RRC) message, a medium access control element (MAC CE) or a downlink control information (DCI).

15. The apparatus of claim 11, wherein the at least one processor is further configured to: selectively transmit the value of the first timer in the message based on an occurrence of a condition or a trigger event depending at least on a UE capability, a type of the RA procedure or the SDT procedure, a cell coverage, or a frequency range.

16. The apparatus of claim 11, wherein the at least one processor is further configured to:
receive scheduling information for DL reception or UL transmission that includes a time offset in response to the value of the first timer reported by the UE, wherein the time offset provided by the serving cell is no less than a BWP switch delay and a measurement gap of the UE.

17. The apparatus of claim 7, wherein the at least one processor is further configured to:
transmitting, in an uplink signal associated with the RA procedure or the SDT procedure, a request for random access response (RAR) window adjustment based on a BWP switch delay and a measurement gap of UE in the second DL BWP.

18. The apparatus of claim 17, wherein to switch from the first DL BWP or the first UL BWP to the second DL BWP, the at least one processor is further configured to: switch from the first DL BWP or the first UL BWP to the second DL BWP following transmission of the request, or based on a BWP retuning schedule received from the serving cell in system information or a dedicated radio resource control (RRC) message.

19. The apparatus of claim 17, wherein the at least one processor is further configured to:
receive, prior to transmitting a random access message, signaling enabling the request for the RAR window adjustment from the UE, wherein the signaling is received from the serving cell in system information, a dedicated radio resource control (RRC) message, a medium access control element (MAC CE) or a downlink control information (DCI).

20. The apparatus of claim 17, wherein the at least one processor is further configured to: selectively transmits the request based on an occurrence of a condition or a trigger event, which depends on at least one of a UE capability, a type of the RA procedure or the SDT procedure, a cell coverage, or a frequency range.

21. The apparatus of claim 1, wherein the at least one processor is further configured to:
transmit, in an uplink signal associated with the RA procedure or the SDT procedure, a request for an on-demand transmission of a non-cell defining SSB (NCD-SSB), tracking reference signal (TRS) or other DL reference signal in the first DL BWP.

22. The apparatus of claim 21, wherein the at least one processor is further configured to:
receive, prior to transmitting the request, signaling from the serving cell enabling the request, wherein the signaling is received in system information, a dedicated radio resource control (RRC) message, a medium access control element (MAC CE), or a downlink control information (DCI).

23. The apparatus of claim 21, wherein the at least one processor is further configured to: transmit the request based on an occurrence of a condition or a trigger event.

24. The apparatus of claim 21, wherein the at least one processor is further configured to:
receive an acknowledgement for the on-demand transmission of the NCD-SSB, the TRS, or the other DL reference signal, wherein performing the time or frequency synchronization includes measuring the NCD-SSB, the TRS or the other DL reference signal in the first DL BWP after receiving the acknowledgement.

25. The apparatus of claim 21, wherein the at least one processor is further configured to:
receive a negative response declining the request from the UE; and
switch from the first DL BWP or the first UL BWP to the second DL BWP to measure the SSB or the reference signal in the second DL BWP after receiving the negative response.

26. An apparatus for wireless communication at a base station, comprising:
a memory; and
at least one processor coupled to the memory and configured to:
transmit, to a user equipment (UE) in a radio resource control (RRC) idle, inactive or connected state, a configuration for random access procedure or a small data transmission (SDT) procedure in a first downlink (DL) and uplink (UL) bandwidth part (BWP) pair, including information indicative of at least one of a control resource set (CORESET), a search space (SS) set, a set of uplink resource occasions for the random access procedure or the SDT procedure, and a synchronization signal block (SSB) or DL reference signal in a second DL BWP, wherein a first DL BWP of the first DL and UL BWP pair does not include the SSB, and a quasi co-location (QCL) source, a spatial relation configuration and synchronization for the UE during the random access procedure or the SDT procedure are based on the SSB or the DL reference signal transmitted by a serving cell in the second DL BWP; and
receive an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair.

27. The apparatus of claim 26, wherein the at least one processor is further configured to: receiving, in the random access message or the SDT message, one of:
a value of a timer associated with a BWP switch from the first DL BWP or the first UL BWP to the second DL BWP for the UE to measure the SSB or the downlink reference signal of the serving cell, or
a second request for a random access response (RAR) window adjustment based on a BWP switch delay and measurement gap to measure the SSB or the DL reference signal in the second DL BWP, wherein the at least one processor is further configured to:
schedule downlink transmission or uplink reception with the UE with a time offset for the BWP switch delay and the measurement gap of the UE to switch from the first DL BWP or the first UL BWP to the second DL BWP to measure the SSB or the DL reference signal.

28. The apparatus of claim 26, wherein the at least one processor is further configured to:
receive, in the random access message in the first UL BWP, a second request for on-demand transmission of a non-cell defining SSB (NCD-SSB), a tracking reference signal (TRS), or another DL reference signal in the first DL BWP; and
transmit, in response to the request, at least one of:
an acknowledgment and a reference signal configuration for one of the NCD-SSB, the TRS, or the other DL reference signal, or
a response message declining the second request.

29. A method of wireless communication at a user equipment (UE), comprising:
receiving a configuration for a first downlink (DL) and uplink (UL) bandwidth part (BWP) pair including information indicative of at least one of a control resource set (CORESET), a search space (SS) set, and a set of UL resource occasions for a random access (RA) procedure or a small data transmission (SDT) procedure;
initiating at least one of the RA procedure or the SDT procedure in the first DL and UL BWP pair; and
performing time or frequency synchronization during the RA procedure or the SDT procedure, using a synchronization signal block (SSB) of a serving cell configured in a second DL BWP or a DL reference signal of the serving cell configured in the second DL BWP or in a first DL BWP of the first DL and UL BWP pair.

30. A method of wireless communication at a base station, comprising:
transmitting, to a user equipment (UE) in a radio resource control (RRC) idle, inactive or connected state, a configuration for random access procedure or a small data transmission (SDT) procedure in a first downlink (DL) and uplink (UL) bandwidth part (BWP) pair, including information indicative of at least one of a control resource set (CORESET), a search space (SS) set, a set of uplink resource occasions for the random access procedure or the SDT procedure, and a synchronization signal block (SSB) or DL reference signal in a second DL BWP, wherein a first DL BWP of the first DL and UL BWP pair does not include the SSB, and a quasi co-location (QCL) source, a spatial relation configuration and synchronization for the UE during the random access procedure or the SDT procedure are based on the SSB or the DL reference signal transmitted by a serving cell in the second DL BWP; and
receiving an early indication from the UE for one or more of a device type, a first request for a first on-demand transmission of the SSB or the DL reference signal, or other assistance information for adaptive scheduling in at least one of a random access message or an SDT message from the UE in a first UL BWP in the first DL and UL BWP pair.
